(19) United States
(12) Patent Application Publication
(10) Pub. No.: US 2006/0225107 A1
(43) Pub. Date: Oct. 5, 2006

(54) System for running applications in a resource-constrained set-top box environment

(75) Inventors: Logananth Seetharaman, Redmond, WA (US); Min Liu, Redmond, WA (US); Edmund H. Lui, Bellevue, WA (US); Dennis G. Cronin, Bellevue, WA (US); Adam T. Mollis, Kirkland, WA (US); Vijaye G. Raji, Redmond, WA (US); Peter T. Barrett, San Francisco, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/097,840

(22) Filed: Apr. 1, 2005

(51) Int. Cl. H04N 7/16; H04N 7/173

(52) U.S. Cl. 725/100; 725/131; 725/151

(57) ABSTRACT

A system is described that is specifically adapted for use in a resource-constrained set-top box environment. The system uses an interpreter-based common language runtime (CLR) that is specifically configured for use in the set-top box environment. The system also includes a unique application manager and UIpane manager that are specifically configured for use in the set-top box environment. The application manager pauses a current application when another application presents a user interface presentation which interferes with the current application's user interface presentation. In addition, the system includes graphics functionality for providing transitions effects, for allowing a user to change color palette and resolution, and so forth. The graphics functionality directly uses the graphics capabilities of the set top box (such as the set top box's line control register) whenever possible to enable applications to execute more quickly.

### TECHNICAL FIELD

This subject matter relates to developing and running applications in a resource-constrained environment, such as a resource-constrained set-top box environment.

### BACKGROUND

Set-top boxes receive media information from a source (such as a head-end distribution site), process the media information, and present the processed media information on an output device (such as a conventional television unit). There is a growing demand to provide functionality which will enable existing and future television set-top boxes to run more versatile and interesting applications. Exemplary applications include game applications, video on demand (VOD) and electronic program guide (EPG) applications, news presentation applications, and so forth.

One approach to improving the versatility of set-top boxes is to duplicate the features of a “full scale” desktop programming environment in a set-top box platform. One exemplary framework in use today is Microsoft Corporation's .NET Framework. .NET technology provides a virtual machine (VM) environment for executing programs in a manner which is generally independent of the underlying complexities in the physical platform used to implement the execution. By way of broad overview, the .NET Framework uses a compiler to convert source code (e.g., C# source code) into intermediate language (IL) code and metadata. In an execution phase, the .NET Framework uses a common language runtime (CLR) loader and a just-in-time (JIT) compiler to transform the IL and metadata into the native code specific to a particular execution platform.

Other technology extends the above-described virtual machine principles for use in resource-constrained computing devices. (Such technology, which employs the use of a just-in-time compiler in resource-constrained environments, is referred to as “compact JIT-based technology” herein.) For example, Microsoft Corporation's .NET Compact Framework (.NET CF) adapts the above-described “full scale” .NET Framework for use in resource-constrained computing devices. Such compact JIT-based technology can inherit the full .NET Framework architecture of the common language runtime (CLR), supports a subset of the .NET Framework class library, and contains classes designed exclusively for .NET CF. In operation, such compact JIT-based technology can use a JIT compiler to execute the intermediate language instructions. Supported devices include personal data assistants (PDAs) (such as the Pocket PC), mobile phones, some set-top boxes, automotive computing devices, and custom-designed embedded devices. In general, such compact JIT-based technology (such as .NET CF) is optimally designed for systems with at least 8-16 MB of RAM.

The above compact JIT-based technology provides feasible solutions in many kinds of set-top boxes. However, this technology is not fully satisfactory for use in all set-top boxes, such as set-top boxes with particularly limited amounts of resources. For example, the popular DCT 2000 set-top box, provided by Motorola Inc. of Schaumburg, Ill., includes a 27 MHz CPU and a limited amount of memory (e.g., 1.5 MB of RAM and 1.25 MB of flash memory). These resources do not present an optimal platform on which to run compact JIT-based applications. For example, the JIT used in a conventional .NET environment needs to keep both the original IL assembly and also the “jitted” native code in memory. This requirement can overtax the memory resources of the resource-constrained set-top boxes. Further, JIT-based technology works by JIT-compiling all managed code prior to running it. This produces an undesirable delay when starting up an application.

As a consequence of the above-identified factors, the use of compact JIT-based technology for severely resource-constrained set-top boxes results in poor performance. For example, this solution may cause the applications to run intolerably slow. This solution may also outright prevent the development of some new application features.

For at least the above-identified reasons, there is an exemplary need for more satisfactory systems for developing and running applications on resource-constrained set-top boxes and in other resource-constrained environments.

### SUMMARY

According to one exemplary implementation, a set-top box system is described herein, comprising: a hardware layer representing hardware functionality provided by the set-top box and an interpreter-based core runtime engine (e.g., an interpreter-based common language runtime) configured for use in a set-top box environment. The set-top box system is configured to run an application that can perform a function using the hardware layer and the interpreter-based core runtime engine.

According to another exemplary feature, the set-top box system includes less than 5 MB of memory.

According to another exemplary feature, the set-top box system further includes an application manager for managing applications, configured for use in the set-top box environment.

According to another exemplary feature, the application manager is configured to pause a current application when another application is activated, and to resume the current application when the other application is deactivated.

According to another exemplary feature, the set-top box system further includes a UIpane manager for managing user interface presentations, configured for use in the set-top box environment.

According to another exemplary feature, the set-top box system further includes graphics functionality configured to perform one or more of:
provide a transition effect when switching from one graphical presentation to another (such as decimation, fading, scrolling, exposing and so forth);
change a color palette of a graphical presentation;
change a resolution of a graphical presentation;
simplify font processing by stripping information, from font files; and
provide anti-aliasing for fonts.

According to another exemplary feature, the above-mentioned hardware functionality of the set-top box system includes a line control register (LCR) which provides memory locations which correspond to respective lines on a display device, and is wherein the set-top box system further comprises graphics functionality configured to provide a graphical effect by manipulating the LCR.

Additional exemplary implementations are described in the following.

### BRIEF DESCRIPTION OF THE DRAWINGS

FIG. 1 shows an overview of a system that includes set-top boxes that implement an improved system described herein.

FIG. 2 shows an overview of a physical construction of an exemplary set-top box used in the system of FIG. 1.

FIG. 3 shows a hierarchy of software functionality that can be implemented by the set-top box of FIG. 2.

FIG. 4 shows a hierarchical organization of UIpane classes provided by the functionality of FIG. 3.

FIG. 5 shows a mechanism used to load and execute applications provided by the functionality of FIG. 3.

FIG. 6 illustrates the operation of navigation functionality provided by the functionality of FIG. 3.

FIG. 7 shows a procedure that sets forth a manner of operation of the functionality of FIG. 3.

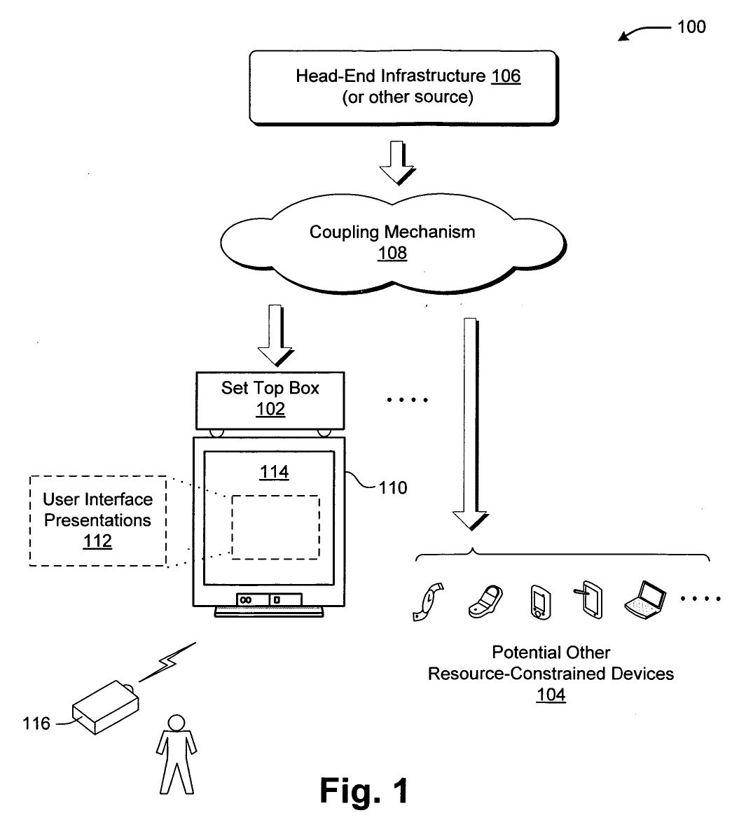

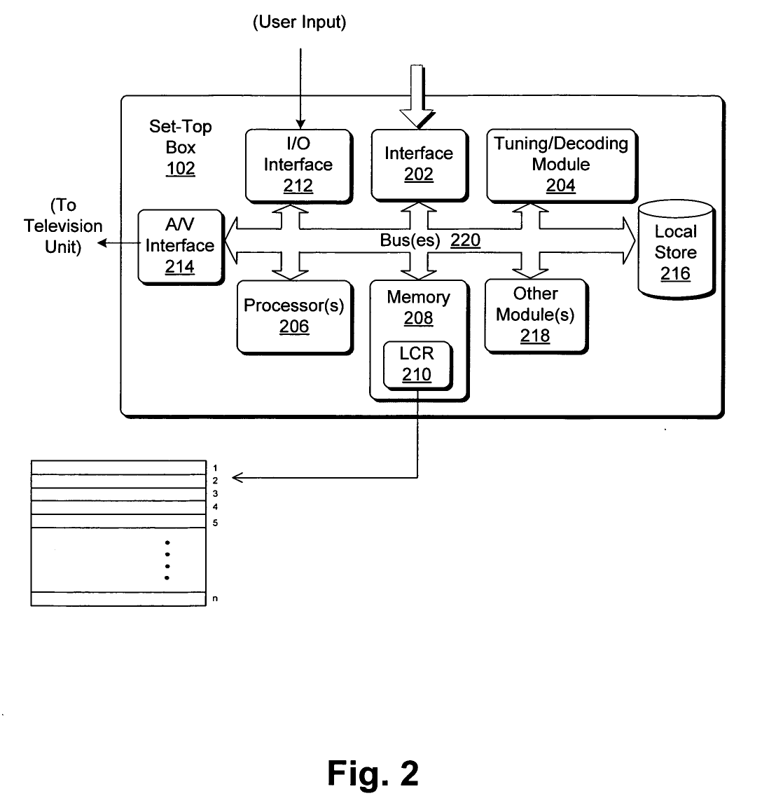

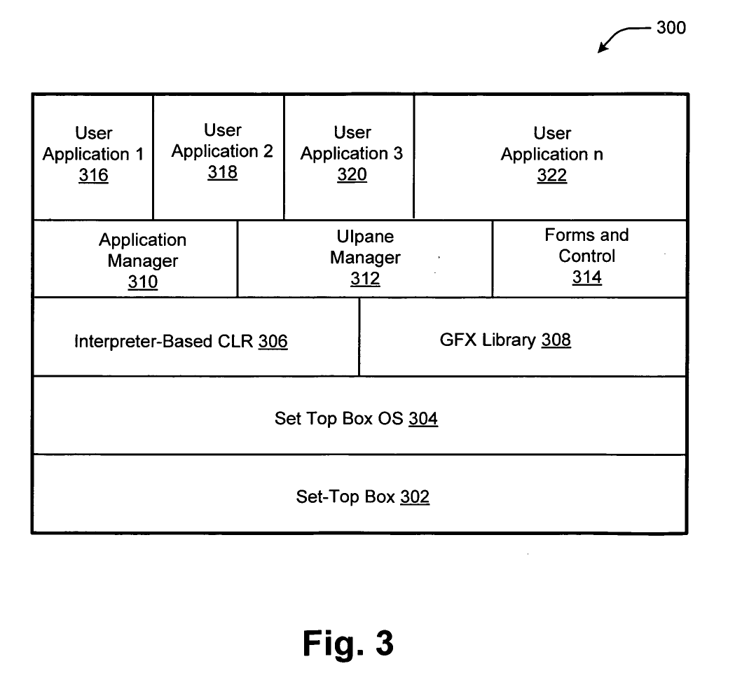

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The following description sets forth a system for developing and running applications in a set-top box environment and in other resource-constrained environments. In one exemplary implementation, the system uses an interpreter-based common language runtime (CLR) that is adapted for use in a set-top box environment. For example, the interpret-based CLR can be implemented using, but is not limited to, Microsoft Corporation's Smart Personal Objects Technology (SPOT) functionality.

Among the improvements, the system described herein provides the following features:
The system provides a flexible and efficient framework to develop rich applications, such as digital video recorder (DVR) applications, tuning-related applications, parental control-related applications, program guide and search applications, video on-demand (VOD) applications, game applications, information (e.g., news) presentation applications, voting applications, instant messenger (IM) applications, and many others. The system also supports user applications written using the C# language (among other languages).
The system provides a new “TV” namespace to simplify programming on the set-top box (compared to the “full scale”.NET Framework or known compact versions thereof). Overall, the functionality referenced by the namespace consumes much less resources compared to the full scale .NET environment or compact versions thereof. At the same time, the system uses a programming framework that complements the .NET Framework, allowing programmers to begin programming for the set-top box with very little additional training.
The system provides a unique application manager for supporting multiple applications running at the same time. Among other features, the application manager provides a pause/resume mechanism and a notification framework to manage different applications running at the same time (even though these applications might use different system color palettes, different display resolutions, etc). For example, when a second user interface presentation (associated with a second application) takes the place of a first user interface presentation (associated with a first application), the system can automatically pause the first application, allowing the second application to receive the majority of the system's processing power. In this manner, the system can thereby prevent user interface presentation from overlapping each other.
The system provides a UIpane manager to provide more appropriate user controls (tailored to the set-top box environment) with limited set-top box resource. For example, the system adopts new UIpane forms.
The system provides graphics functionality that allocates as much rendering as possible to the set-top box hardware. This results in graphics functions that run very quickly, while consuming minimal resources. Among other features, the graphics functionality provides full 256 color support, and provides the ability to switch color palettes and resolutions upon switching from one application to another. The graphics functionality also provides transition effects when switching from one application to another. The transition effects operate by directly manipulating the set-top boxes line control register (LCR). The system also leverages some of the fastest algorithms provided in other systems, such as algorithms for rendering lines, ellipses, rounded rectangles, and so forth.
The system also provides a resource-efficient font installation and management algorithm, and a resource-efficient anti-aliased true type font rendering algorithm. To further reduce resource consumption, the system also uses a font-stripping mechanism to strip out some of the information from the font files.

The strategies described herein confer a number of benefits. According to one principal benefit, the system provides a powerful framework for developing interesting and versatile applications on very resource-constrained set-top boxes. At the same time, the system complements previous frameworks, and therefore can leverage a programmer's existing knowledge of those frameworks (and associated programming languages, such as C#).

Additional features and attendant benefits of the strategies will be set forth in this description. At the outset, while the following discussion is framed principally in the context of the use of interpreter-based CLR technology for deployment in a set-top box environment (such as the above-described SPOT technology), other types of resource-efficient technology can be used as a foundation to construct to the system. Moreover, such other memory-efficient technology does not need to adopt the .NET paradigm (or any virtual machine framework paradigm). Further, while the system is optimally suited for deployment in a resource-constrained environment, it is not limited to such an environment; for example, the system can be used in an environment that has enough processing resources to accommodate a full .NET deployment. Further, the system can be used on other devices (besides set-top boxes), such as any kind of wearable device (e.g., a wristwatch device), a personal digital assistant (PDA) device, a mobile phone, and so forth.

As to terminology, the term media information refers to any data represented in electronic form that can be consumed by a user. The media information can include any information that conveys audio and/or video information, such as audio resources (e.g., music, spoken word subject matter, etc.), still picture resources (e.g., digital photographs, etc.), moving picture resources (e.g., audio-visual television programs, movies, etc.), computer programs (e.g., games, etc.), and so on.

The term UIpane represents a graphics object for presentation to the user. In one case, the UIpane may correspond to a Windows™-type user interface pane.

The term On Screen Display (OSD) refers to the display presentation enabled by the set-top box.

In addition to the above terms, this disclosure uses many standard .NET terms. The reader is referred to any number of introductory texts for a background understanding of .NET concepts, including: David Chappell, Understanding .NET. A Tutorial and Analysis, Addison-Wesley publishers, 2002; and David S. Platt, Introducing Microsoft .NET, Microsoft Press, 2003. Still additional information regarding the .NET environment can be found on Microsoft Corporation's technical library, provided online by Microsoft's MSDN site. The following glossary, containing prevalent terms in this disclosure, is derived from information provided at the MSDN site.
An assembly refers to collection of one or more files that are versioned and deployed as a unit. An assembly is the primary building block of a .NET Framework application. All managed types and resources are contained within an assembly and are marked either as accessible only within the assembly or as accessible from code in other assemblies.
The C# (pronounced “C sharp”) language refers to one programming language designed for building applications that run on the .NET Framework. C#, which is an evolution of C and C++, is type safe and object-oriented.
A callback function refers to an application-defined function that a system or subsystem calls when a prescribed event happens.
A class is a reference type that encapsulates data (constants and fields) and behavior (methods, properties, indexers, events, operators, instance constructors, static constructors, and destructors), and can contain nested types. Class types support inheritance, a mechanism whereby a derived class can extend and specialize a base class.
A constructor refers to a special initialization function that is called automatically whenever an instance of a class is declared. The constructor must have the same name as the class itself and must not return a value.
A delegate is a reference type that is the managed version of a C++ function pointer.
Common language runtime (CLR) refers to an engine at the core of managed code execution. The runtime supplies managed code with services such as cross-language integration, code access security, object lifetime management, and debugging and profiling support. The term “core runtime engine” is used herein to describe functionality that provides the above-described types of services, and thus encompasses CLR technology, but it not limited to CLR technology (and, indeed, is also not limited to .NET technology).
A context refers to an ordered sequence of properties that define an environment for the objects resident inside it.
Enumeration (enum) refers a special form of value type that inherits from System.Enum and supplies alternate names for the values of an underlying primitive type. An enumeration type has a name, an underlying type, and a set of fields.
A form (such as a Windows-type Form) refers to a composite control that provides consistent behavior and user interface within or across applications.
Garbage collection (GC) refers to a process for removing objects that are no longer being used.
JIT compilation refers to compilation (in a conventional “full scale” .NET environment) that converts intermediate language (MSIL) into machine code at the point when the code is required at run time.
Lifetime refers to the time period that begins when an object is allocated in memory and ends when the garbage collector deletes the object from memory.
Managed code refers to code that is executed by the common language runtime environment. Managed data refers to objects having lifetimes that are managed by the common language runtime.
A namespace refers to a logical naming scheme for grouping related types. The .NET Framework uses a hierarchical naming scheme for grouping types into logical categories of related functionality.
A private assembly refers to an assembly that is available only to clients in the same directory structure as the assembly.
Reflection refers to a process of obtaining information about assemblies and the types defined within them, and creating, invoking, and accessing type instances at run time.

A Uniform Resource Identifier (URI) refers to a number or name that uniquely identifies an element or attribute. URIs include both Uniform Resource Names (URNs) and Uniform Resource Locators (URLs).
Unmanaged code refers to code that is executed directly outside the common language runtime environment.
Extensible Markup Language (XML) refers to a subset of Standard Generalized Markup Language (SGML) that is optimized for delivery over the Web. XML provides a uniform method for describing and exchanging structured data that is independent of applications or vendors.

This disclosure includes the following sections.

A. System Overview (FIGS. 1 and 2)
A.1. The System
A.2. The Set-top Box

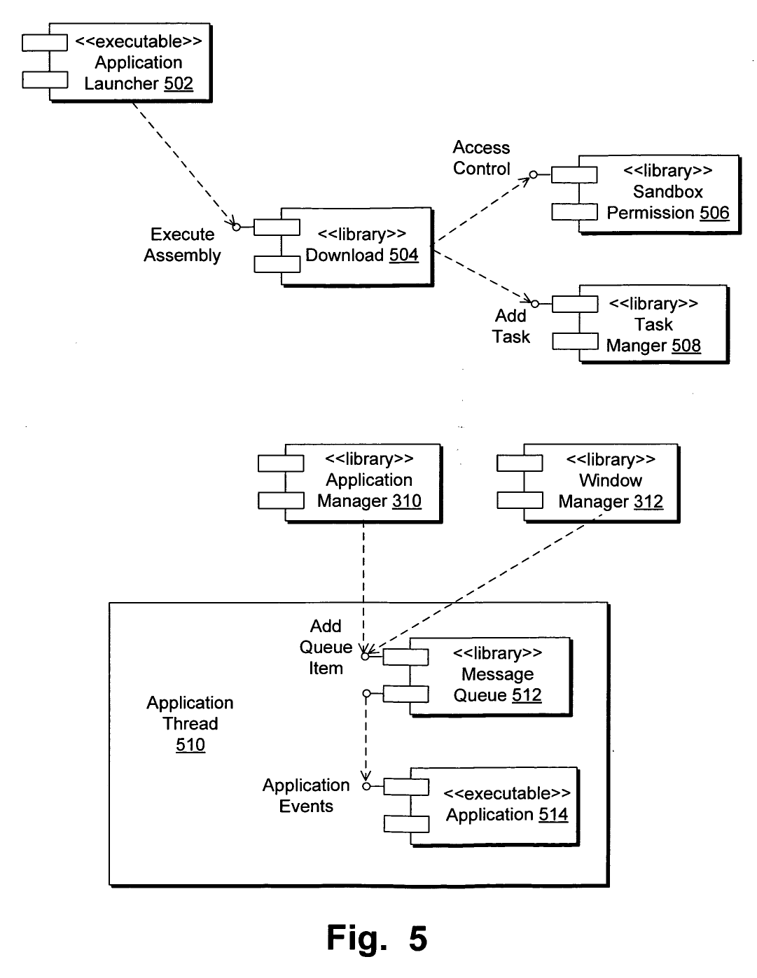

B. Exemplary System Software Functionality (FIGS. 3-6)
B.1. Overview of the Functionality
B.2. ApplicationBase Functionality
B.3. UIpane Functionality
B.4. Application Manager
   B.4.1. Initialization Behavior
   B.4.2. Execution and Memory Management Behavior
   B.4.3. Pause and Resume Behavior
   B.4.4. Unloading/Termination Behavior
   B.4.5. Miscellaneous Behavior
   B.4.6. Summary (FIG. 5)
B.5. UIpanes Manager
   B.5.1. UIpane Management Behavior
   B.5.2. Event Routing Behavior
   B.5.2. UIpane Focus and Navigation Behavior
B.6. Graphics Features
   B.6.1. Transition Effects
   B.6.2. Palette and Resolution Effects
   B.6.3. Blt Effects
   B.6.4. Font Rendering Functionality

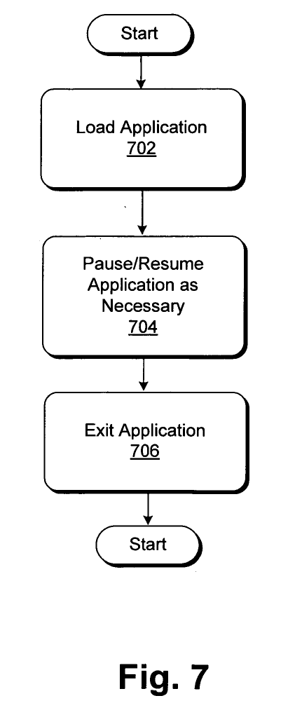

C. Exemplary Method of Operation (FIG. 7)

D. Appendix
D.1. The IUIpane Interface
D.2. ABC_Co.TV.Lite.UIpanes
   D.2.1. ABC_Co.TV.Lite.UIpanes Namespace Overview
   D.2.2. ABC_Co.TV.Lite.UIpanes.UIpaneBase
   D.2.3. ABC_Co.TV.Lite.UIpanes.Form
   D.2.4. ABC_Co.TV.Lite.UIpanes.Control
   D.2.5. ABC_Co.TV.Lite.UIpanes.Button
   D.2.6. ABC_Co.TV.Lite.UIpanes.UIpaneEventHandler
   D.2.7. ABC_Co.TV.Lite.UIpanes.KeyEventHandler
   D.2.8. ABC_Co.TV.Lite.UIpanes.Transition
   D.2.9. ABC_Co.TV.Lite.UIpanes.TransitionEventHandler
   D.2.10. ABC_Co.TV.Lite.UIpanes.ButtonStyle
   D.2.11. ABC_Co.TV.Lite.UIpanes.Keys
D.3. ABC_Co.TV.Lite.Shell.TVLiteApplicationBase
D.4. ABC_Co.TV.Lite.Drawing Namespace
   D.4.1. Overview
   D.4.2. ABC_Co.TV.Lite.Drawing.Graphics Class
   D.4.3. RLE Compressed Image Format Used in ABC_Co.TV.Lite
D.5. Font Methods
   D.5.1. Installing and Deinstalling Fonts
   D.5.2. Graphics Object Font-Related Methods
D.6. Native Events and Managed Async CallBack.

A. System Overview (FIGS. 1 and 2)

Generally, any of the functions described with reference to the figures can be implemented using software, firmware (e.g., fixed logic circuitry), manual processing, or a combination of these implementations. The term “logic, “module” or “functionality” as used herein generally represents software, firmware, or a combination of software and firmware. For instance, in the case of a software implementation, the term “logic,” “module,” or “functionality” represents program code (and/or declarative-type instructions) that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

A.1. The System

FIG. 1 shows an overview of a system 100 in which the improved functionality described herein can be deployed. By way of overview, the system 100 includes a plurality of resource-constrained devices (102, 104) for receiving media information (or other information) from a source 106 via a coupling mechanism 108.

In the case of media distribution, the source 106 can represent head-end infrastructure for delivering media information to the receiving devices (102, 104). For example, the source 106 may represent conventional cable media distribution infrastructure, conventional wireless media distribution infrastructure (such as satellite media distribution infrastructure), and so forth. Or the source 106 may represent a network source of media information that delivers the media information via one or more digital networks. In still another case, the source 106 may represent an entity (such as a video jukebox, etc.) which supplies media information to the receiving devices (102, 104) from a location which is local with respect to the receiving devices (102, 104). In any case, the source 106 can deliver media information to the receiving devices (102, 104) in a number of broadcast channels according to a fixed time schedule, e.g., as reflected by an electronic program guide (EPG). Or the source 106 can deliver media information to the receiving devices (102, 104) using an on-demand method.

The coupling mechanism 108 couples the source 106 to the receiving devices (102, 104). This coupling mechanism 108 can be implemented in different ways to suit different technical and commercial environments. For instance, the coupling mechanism 108 can include any kind of conventional distribution infrastructure, such as cable routing infrastructure, satellite routing infrastructure, terrestrial antenna routing infrastructure, and so forth (as well as any combination of such routing infrastructures). Or the coupling mechanism 108 can include a digital network (or combination of networks), such as a wide area network (e.g., the Internet), an intranet, and so forth. In the case where Digital Subscriber Line (DSL) infrastructure is used to disseminate information, the coupling mechanism 108 can utilize the services, in part, of telephone coupling infrastructure.

For the illustrative purposes of this description, the simplifying assumption will be made that the source 106 and coupling mechanism 108 provide cable or satellite delivery of media information to the receiving devices (102, 104). The link between the source 106 and the receiving devices (104, 106) can implemented as a one way link (where information flows only from the source 106 to the receiving devices), or preferably as a two way link (where the users of the receiving devices can also send data to the source 106). In the case in which two way communication is used, the device-to-source link can be implemented by the same channel that the devices (102, 104) use to receive media information from the source 106, or by a different channel.

The receiving devices include a set-top box 102. The set-top box 102 receives media information from the source 106, performs various processing on the received media information (such as decoding the media information and potentially decompressing it), and forwards the processed information to an output device. In the case of a media distribution environment, the output device can correspond to a television unit 110. In one case, the set-top box 102 can be implemented as a separate unit from the television unit 110, and it can couple to the set-top box 102 via any kind of coupling mechanism (e.g., physical wiring, wireless coupling, and so forth). In another case, the set-top box 102 can be implemented as an integral unit within the television unit 110. In still other cases, the output device that receives media information from the set-top box 102 can comprise another kind of display device besides a conventional television (such as a computer monitor), an audio output device (such as a stereo system), and so forth.

The other receiving devices 104 can comprise any mechanism having processing and output functionality, such as any kind of wearable processing mechanism (e.g., a wristwatch, such as the Microsoft's SPOT watch), a mobile telephone, a personal digital assistant (PDA), a tablet-type device, and so forth. However, to facilitate discussion, the remainder of this description will assume that the receiving device corresponds to the set-top box 102 (which, as stated, can be separate from the television unit 110 or integrated with the television unit 110).

The set-top box 102 includes functionality (to be described) which can present user interface presentations 112 on a display surface 114 of the television unit 110. The display surface 114 is also referred to herein as the on-screen display (OSD). A user can interact with the user interface presentations 112 via a remote control device 116, or some other kind of input device. For example, the set-top box 102 may include input keys (not shown) directly integrated in its housing.

A.2. The Set-Top Box

FIG. 2 shows the composition of the exemplary set-top box 102. The set-top box 102 can include a number of modules for performing its ascribed tasks, identified below.
To begin with, the set-top box can include an interface module 202. The interface module 202 can represent any functionality for receiving media information from the source 106 using any coupling mechanism. For example, the interface module 202 can include a DSL modem, a cable modem, a wireless network interface, an Ethernet NIC, or other kind of network interface equipment.
The set-top box 102 can also include a tuner/decoder module 204 for performing any kind of initial processing on the received media information, such as decoding the media information, potentially decompressing the media information, and so forth. In the case of broadcast services, the tuning/decoding module 204 can select one or more channels of media information via any kind of tuning mechanism (such as by tuning to a prescribed physical frequency that provides a desired channel, and so forth). In the case of network delivery of media information, the tuning/decoding mechanism can rely on virtual tuning mechanisms to receive a channel (e.g., by “tuning” to a prescribed unicast or multicast source of media information).
The set-top box 102 can include one or more processors 206 for executing instructions to implement the functionality of the set-top box 102.
The set-top box 102 can include memory 208 (such as RAM memory, flash memory, etc.). A portion of the memory 208 may comprise a FIFO-type buffer (not shown) for storing media information prior to the information being decoded. Another portion of the memory may comprise a line control register (LCR) 210. The LCR 210 includes respective memory locations corresponding to each line on the display surface of the output device. The set-top box 102 can render information to the output device using the LCR 210. As will be described, the set top box 102 can also provide various graphics effects (such as transition effects) by manipulating the LCR 210.
The set-top box 102 can include an I/O interface 212 for interacting with the user via one or more input devices (e.g., a remote controller 116, and so forth).
The set-top box 102 can include an A/V interface module 214 for providing media information in an appropriate format to the television unit 110 (or other output device).
The set-top box 102 can include an optional local store 216 for storing any kind of data and/or program information.
The set-top box 102 can include various other modules 218, not specifically enumerated in the figure. For instance, the set-top box 102 can include a graphics compositor for combining a video component of the media information from the tuning/decoding module 204 with graphics information. The graphics information may comprise various user interface presentations which are overlaid on the media information.

Finally, the set-top box 102 can include one or more buses 220 for coupling the above-identified components together.

Additional information regarding a wide range of set-top boxes can be found in a number of sources, such as the online TV dictionary, in an online article entitled, “What are Set-top Boxes.”

In any event, the system to be described below is particularly suited for set-top boxes having constrained processing resources (although it is not restricted to boxes having constrained resources). For example, the popular DCT 2000 box produced by Motorola has limited resources. The processor of this box operates at 27 MHz, and the memory comprises 1.5 MB of RAM and 1.25 MB of flash memory. The challenge met by the invention is to provide suitably diverse functionality for these kinds of resource-constrained environments in which to develop and run applications.

According to one exemplary implementation, the system can employ an interpreter-based common language runtime (CLR) that is adapted for use in the set-top box environment. This is in contrast to the above-summarized compact just-in-time-based (compact JIT-based) approach. In the JIT-based approach, the platform requires JIT-compilation of all of the managed code prior to start-up of an application. This has at least two disadvantages. First, the JIT-compilation produces a lag before the application is run. Second, the JIT-compilation requires a significant amount of memory to store the original assembly and the “jitted” native code. In contrast, the interpreter-based CLR provides interpretation and execution of code on a piecemeal basis, that is, by interpreting code on an as-needed basis. This reduces both the time required to start up an application and the memory requirements of an application; the latter of the advantages is particularly valuable for resource-constrained devices which have limited memory resources.

The interpreter-based CLR can be implemented using different technologies. In one exemplary and non-limiting case, the interpreter-based CLR can be implemented by Microsoft Corporation's Smart Personal Objects Technology (SPOT). SPOT technology is described in a number of sources, including an online article by Donald Thomson entitled “Smart Personal Object Technology (SPOT): Part I: An introduction to hardware, network, and system software.” Literature describing .NET embedded is technology is relevant to SPOT technology. More specifically, netcpu™ Corporation of Seattle Wash. provides a netcpu™ product and associated SDK that is relevant to SPOT technology.

The above-described technology-specific implementations are merely illustrative. Other interpreter-based functionality can rely on other programming frameworks besides the .NET framework, such as the Java programming framework, and so forth. As defined above, the more general term “interpreter-based core runtime engine” encompasses the use of an interpreter-based CLR (such as SPOT's TinyCLR), but is not limited to this technology (and, indeed, is also not limited to .NET technology).

The interpreter-based CLR can be adapted for use in the set-top box environment in ways that will be fully described in the ensuing sections of this disclosure. Generally, the interpreter-based CLR can provide a reduced set of functionality compared to that provided by the “full scale”.NET Framework. Yet the interpreter-based CLR preferably generally conforms to the .NET paradigm, allowing developers to provide applications using the .NET paradigm in very resource-constrained environments.

More specifically, a desktop environment receives input from a user via several possible input devices, such as a keyboard and a mouse. Further, a desktop environment is configured to provide a very complex user interface presentation, with multiple overlapping UIpanes, demanding an equally complex UIpane management strategy. A set-top box environment, by contrast, receives input from the user typically via a limited number of simple input mechanisms (e.g., a remote controller). Further, a set-top box environment is typically expected to provide multiple applications, but typically does not present these applications in a complex layered fashion (unlike the desktop environment). As such, according to the invention, the interpreter-based CLR platform is adapted to optimally service the set-top box environment.

As will be described in the next section, exemplary improvements include: a namespace specifically tailored for the set-top box environment; a unique application manager for pausing and resuming applications; a unique window manager; and various unique graphics and font-related provisions.

B. Exemplary System Software Functionality (FIGS. 3-6)

B.1. Overview of the Functionality

FIG. 3 provides an overview of the set-top box system's software stack 300, referred to herein as TV.Lite (because it provides relatively “lightweight” functionality for use in the television set-top box environment). As mentioned above, the stack 300 can include functionality provided by an interpreter-based CLR, adapted for use in a set-top box environment according to the unique provisions described herein. In conventional fashion, the layers in the stack 300 refer to the relative dependency of different functionality in the system, with the lowest level performing the most basic functions of the system, and the top level performing the most abstract or high-level functions in the system.

To begin with, the lowest set-top box layer 302 corresponds to the physical structure of the set-top box 102, including its various hardware capabilities. For example, this layer 302 includes the set top box components identified in FIG. 2, including the LCR 210.

The next highest layer, the set-top box OS layer 304, provides various base functions performed by the set-top box 102. For example, for the Motorola DCT 2000 set-top box, the set-top box OS layer 304 corresponds to a “GIOS” operating system provided by Motorola. This layer 304 can provide memory management, scheduling, hardware control, and so forth.

The next highest layer provides an interpreter-based CLR 306 (such as, but not limited to a SPOT-based CLR) and a GFX library 308. Generally, in an exemplary .NET implementation, the interpreter-based CLR 306 contains a subset of .NET common language runtime (CLR) functionality, specifically adapted for the demands of the set-top box environment. The interpreter-based CLR 306 is relatively low in the stack (compared to the “full scale” .NET Framework); this makes the distinction between application functionality and low-level OS functionality less distinct (compared to conventional systems).

The GFX library 308 provides various graphics functionality for use in the set-top box system, which is specifically adapted for use in the set-top box environment.

The next highest layer provides an application manager 310, UIpane manager 312, and forms and control 314. Among other tasks, the application manager 310 controls the loading, running, and shutting down of multiple applications.

The UIpane manager 312 and the forms and control 314 provide various functionality which controls the presentation of UIpanes (such as, but not limited to, display objects similar to those produced in a Windows™ operating system environment). The number of APIs has been condensed in this UIpane functionality (compared to a conventional desktop environment) in order to eliminate functionality that is not needed for the set-top box environment. Yet the APIs complement the full API set provided in the desktop environment, thereby allowing developers to start writing applications for the set-top box environment without learning an entirely new programming paradigm.

The topmost layer provides a number of applications (316, 318, 320, . . . 322). These applications (316, 318, 320, . . . 322) can include any code functionality designed to serve any purpose. For example, these applications (316, 318, 320, . . . 322) can provide digital video recorder (DVR) applications, tuning-related applications, parental control-related applications, program guide and search applications, video on demand (VOD) applications, game applications, information (e.g., news) presentation applications, voting applications, instant messenger (IM) applications, and so forth. The applications (316, 318, 320, . . . 322) also supports user applications written using the C# language (among other languages).

The following subsections provide additional detail regarding the software stack 300 shown in FIG. 3.

B.2. ApplicationBase Functionality

The functionality in the stack 300 can be implemented, in part, by a unique namespace developed for the set-top box environment. At its base, the namespace provides a shell, ABC_Co.TV.Lite.Shell, from which additional functionality can be appended in hierarchical fashion. Child functionality in the hierarchy can rely on the tools provided by parent functionality through inheritance.

This subsection describes the functionality grouped into a namespace referred to as TVLiteApplicationBase (referred to below as ApplicationBase for brevity). The ApplicationBase class depends from the ABC_Co.TV.Lite.Shell. ApplicationBase represents a set-top box application. Namely, all applications should derive from the abstract TVLiteApplicationBase interface. Through this relationship, the applications can implement all the abstract methods specified in ApplicationBase. The Appendix, in Section D, provides a detailed description of the ApplicationBase functionality; this section provides exemplary salient features of this functionality.

The ApplicationBase class can provide the following exemplary and non-exhaustive list of features. (Below-reference to “message pumps” and other features will be clarified in the context of later discussion of the application manager 310.)
A Run method begins running a standard application message loop on a current thread, and makes a specified UIpane visible. The Run method will automatically call RegisterUIpane (identified below) to register a main UIpane as a top level UIpane.
An Initialize method performs application-defined initialization. In this method, the URL of a HTTP request to launch the application along with the parameters that are appended to the URL can be passed to the application via a “url” parameter in a call to Initialize. The following provides an exemplary url parameter:

http://appserver/monster.dat?param1=value1&param2=value2.
An Exit( ) method informs all message pumps that they should terminate, and then closes all application UIpanes after the messages have been processed. The Exit method is typically called from within a message loop, and forces the Run method to return. More generally, an application can call the Exit method to inform the application manager 310 that the application is exiting; this allows the application manager 310 to perform appropriate actions, such as cleaning up system resources, and so forth.
A RegisterUIpane method allows an application to register its top level UIpanes with the UIpane manager 312. The UIpane manager 312 will dispatch UIpane events to the top level UIpane.
A Pause method allows the application manager 310 to send a pause event to the application to request it to pause. The application manager 310 will suspend the thread after requesting the application to pause.
A Resume method allows the application manager 310 to send a resume event to the application to request it to resume.
A Terminate method allows the application manager 310 to send a terminate event to the application to request it to terminate. For example, the Terminate method can be invoked when an application is to be terminated, such as when the user enters an express quit instruction via appropriate UI commands, when the system is being shut down, when the system resources are running low, and so forth. In these circumstances, the application manager 310 calls the Terminate method to instruct the application to terminate.
A ReleaseResource method allows the application manager 310 to send a release resource event to the application to request it to release any resource that can be freed. This includes removing references to objects for the garbage collector.

B.3. UIpane Functionality

The shell also defines a base IUIpane interface that serves as a root base of all UIpanes. This interface allows the UIpane manager to control all the UIpanes without “knowing” the specifics of the implementation of each UIpane.

An ABC_Co.TV.Lite.UIpanes namespace contains classes for creating “light TV applications” that are optimized for execution on low-end set-top boxes (STB). As explained in previous sections, the set-top boxes can run an interpreter-based CLR system.

The classes in this namespace can be grouped into the following categories:
A UIpaneBase class category provides the base functionality for all UIpane controls that are displayed on a TV application. Most classes within the ABC_Co.TV.Lite.UIpanes namespace derive from the UIpaneBase class. The UIpaneBase class is also a container, meaning that it can contain child UIpanes.
A UIpane Forms class category allows for the creation of top level container UIpanes.
A UIpane Controls class category allow for the creation of user interfaces. For example, the Button class is a UIpane control.

There are a number of classes within the ABC_Co.TV.Lite.UIpanes namespace that provide support for the class categories mentioned in the preceding summary. By way of overview, as to classes:
A Button class represents a TV button control.
A Control class defines the base class for controls. A control object defines an object with visual representation that performs a specific function.
A Form class defines the base class for parentless, top level, container UIpanes. Objects produced by this class (form objects) have some or no visual representation, and can contain child UIpanes.
A Transition class defines methods to apply a transition to a form object.
A UIpaneBase class is an abstract class that defines the base class for a UIpane (which defines an object with visual representation or an object that contains other UIpaneBase objects).

As to delegates:
A UIpaneEventHandler class represents the methods that will handle any UIpane event.
A KeyEventHandler class represents the methods that will handle key events.
A TransitionEventHandler class represents the methods that will handle a transition event.

As to enumerations:
A Keys class represents all possible keys codes used in a TV application.
A ButtonStyle class represents all possible button styles.

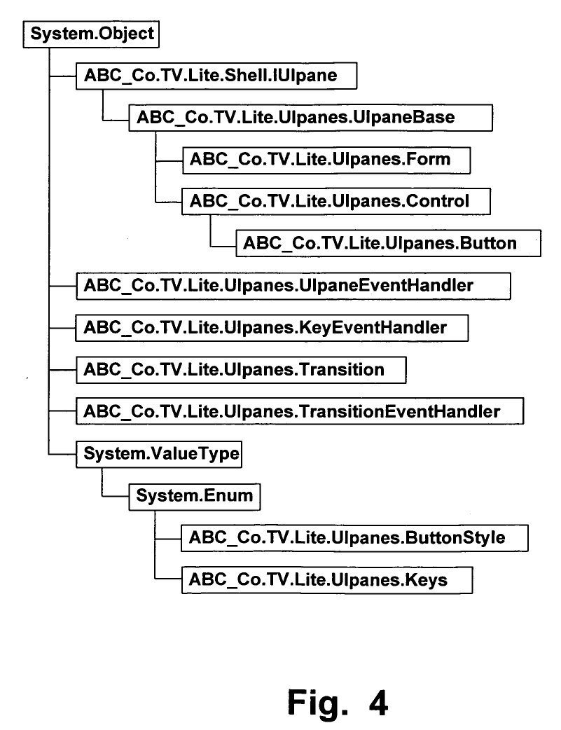

Again, the Appendix, Section D, provides an exhaustive discussion of the UIpane functionality. Further, FIG. 4 shows an exemplary hierarchical organization of this functionality, which provides a summary of the functionality fully set forth in the Appendix.

B.4. Application Manager

The application manager 310 provides a mechanism to manage application loading, unloading, and initialization. The application manager 310 also governs the message pump, performs memory management, handles security-related aspects of the system, and so forth. The application manager 310 also manages application behavior by instructing an application to activate, deactivate, pause, resume, terminate, and so forth.

The follow subsections provide additional information regarding the above topics.

B.4.1. Initialization Behavior

The application manager 310 can receive an application launch request to launch an application. For example, in one exemplary implementation, the launch request can request the application manager 310 to launch an application in flash memory or to launch an application via an HTTP request to download and launch the application.

More specifically, the application shell can use a public Download class in the ABC_Co.TV.Lite.Shell namespace to download and execute an application. Multiple instances of the Download object can be created to download and execute multiple assemblies simultaneously. Each assembly runs in its own thread. (Note that, in certain compact .NET JIT-based frameworks, applications run in different application domains. By contrast, there is no concept of an application domain in the interpreter-based CLR implementation, as applications run in different logical threads.) The Download object can check for permission to launch an application.

An application can use the Download object to launch other applications. If the launching application wants to be notified when the launched application exits, it can pass an AutoResetEvent to the Download constructor and wait on the event. For example, assume that entity X uses the Download object to launch a game application. Entity X can create an AutoResetEvent called gameAppExitEvent and pass it to the Download object. Entity X can create a separate thread and wait on the gameAppExitEvent in that thread. When the game application exits, the Shell will signal the gameAppExitEvent. Entity X should not wait for the gameAppExitEvent in the message pump thread (to be described below) because entity X still needs to respond to system events (such, as pause events, resume events, terminate events, etc).

The Download class contains a public method called ExecuteAssembly to download and execute an assembly. The ExecuteAssembly method will start a new application thread to download, load, and execute an assembly. (Alternatively, or in addition, the Download object can support a method called GetFile that will return a byte array of the assembly. Applications can use the GetFile method to read a block of bytes of the assembly data or file.) After the assembly is downloaded and loaded, the application manager can use Reflection to find the application class by looking for the class that is derived from TVLiteApplicationBase.

Then, the application manager 310 instantiates an instance of TVLiteApplicationBase and calls the Initialize method with the command/URL that launches the application. Thus, the Initialize method constitutes the entry point for the managed application.

The application creates its main UIpane when the Initialize method is called. The application can also use the RegisterUIpane functionality (discussed below) provided in the TVLiteApplicationBase to register additional top-level UIpanes.

B.4.2. Execution and Memory Management Behavior

The application calls the Run method when it is finished with all the initialization work. This will start a message pump, which allows the application to receive events (e.g. focus events, key events, pause events, resume events, terminate events, and so on). The Run method is a blocking call and will not return until the application calls Exit on itself. When the application is finished, it calls the Exit method provided in the base class TVLiteApplicationBase of the application. In other words, the Run method starts the message loop on the current thread and makes the specified UIpane visible. An application calls the Exit method to exit the message pump and return from the Run method.

In the course of running the application, a garbage collector automatically releases the memory allocated to a managed object when that object is no longer used. However, it is unpredictable when garbage collection will occur. TVLiteApplicationBase can be implemented as a managed application that has no direct access to native memory handles, open files and streams. Therefore, the memory management of TVLiteApplicationBase can be handled properly by the garbage collector.

The application manager 310 can call a Purge method to notify the application thread that the system is running low on memory. The application should free (by removing reference to objects) as many managed objects as possible when the Purge method is called. If the system is still running below the minimum memory threshold, the application manager 310 can terminate applications to bring the amount of available memory above the minimum memory threshold. Namely, the application manager 310 can terminate inactive applications based on a first-in-first out algorithm. The application manager 310 will not terminate applications listed in a KeepAlive section in a configuration file.

B.4.3. Pause and Resume Behavior

The application manager 310 calls an application's Pause method to indicate the application thread is about to be suspended. For example, the application manager 310 can automatically call the Pause method to pause a currently running application when another application is activated and that new application's UIpane overlaps the current application's UIpane. The Pause method will provide an opportunity for the application to prepare for thread suspension. The application will not receive any messages until the thread is resumed. The application manager 310 can terminate an application that does not pause within a pre-determined time period (e.g., 0.5 seconds).

The application manager can call the application's Resume method to indicate that the application thread has been resumed. This will provide an opportunity for the application to restore itself to the state existing prior to the thread suspension. The application manager 310 can then restart the message pump of the thread. The application manager 310 can terminate an application that does not resume within a pre-determined time period (e.g., 0.5 seconds).

B.4.4. Unloading/Termination Behavior

The application manager 310 provides the implementation of the Exit method in its base implementation. Namely, the Exit method notifies the application manager 310 to terminate a current application. The application manager 310 will remove the terminated application and transfer control to a previous active application.

The application manager 310 can also call the application's Terminate method to indicate that the application thread should terminate. This will provide an opportunity for the application to exit gracefully. The application manager 310 will terminate an application that does not exit gracefully after a pre-determined period of time.

B.4.5. Miscellaneous Behavior

As to the topic of security, the application manager 310 validates an application's requests against rules specified in a configuration file. For instance, the application manager 310 can check whether an application has permission to launch another application, access network resources, and so on. An application will receive an exception when requesting functionality it does not have permission to use.

As to the topic of registration, an application can register its top level UIpanes with the application manager 310 to receive UIpane events. More specifically, the Run method automatically registers the UIpane specified in its UIpane parameter.

B.4.6. Summary (FIG. 5)

FIG. 5 provides a summary of the above-identified concepts. In this figure, an application launcher 502 invokes the launch of an application by contacting download entity 504. The download entity 504 determines whether it has permission to download and execute the application by accessing the sandbox permission entity 506. If so, the download entity 504 adds a task to the task manager entity 508 to execute the application. Running the application creates an application thread 510 devoted to the application.

The application manager 310 and the window manager 312 control the execution of the invoked application. Namely, these managers (310, 312) add queue items to a message queue entity 512, resulting in the execution of these items by the application entity 514.

B.5. UIpanes Manager

The UIpane manager 312 provides a fully managed UIpane management implementation. The UIpane manager 312 is responsible for UIpanes management, events routing, and focus management. This subsection provides details regarding the behavior of the winpage manager 312.

B.5.1. UIpane Management Behavior

UIpanes are displayed in a prescribed priority based on their type. The supported UIpane types comprise: Notification; Floating (Notification with AlwaysOnTop attribute set); and Normal. A Floating UIpane will always be the top-most UIpane. For example, assume that a display simultaneously presents plural UIpanes corresponding to different applications (or corresponding to the same application). The UIpane that has the highest priority level will receive focus, meaning that a user's input activity will be directed to this UIpane. According to one exemplary implementation, however, UIpanes are not allowed to overlap on the display.

The UIpane manager 312 works closely with the application manager 310 to pause, resume, and terminate applications. For example, the UIpane manager 312 asks the application manager 310 to send a pause event to a current application's message pump when the current application needs to be suspended (typically because another application's UIpane that is about to come up will interfere with the current UIpane). This will give the current application a chance to perform required operations before it goes into a suspended state.

More specifically, an application receives activate and deactivate events when it receives and loses focus respectively. For example, if a notification shows up on top of a running application, the application will receive a deactivate event (followed by a pause event). When the notification is dismissed, the application will receive an activate event (after it has been sent a resume event).

B.5.2. Event Routing Behavior

The UIpane manager dispatches all events to the message pump of the application thread. More specifically, user input events will “bubble up” the UIpanes containment hierarchy until the event is handled or the hierarchy ends (that is, when the event reaches a UIpane that does not consume the event and whose parent is null).

Paint events are dispatched to the top level UIpane of the containment hierarchy only if the UIpane has not been paused. The top level UIpane is responsible for dispatching paint events to its children. For example, if a UIpane has several buttons as its children, the UIpane will receive a paint event and it is responsible for invoking paint on the buttons.

B.5.3. UIpane Focus and Navigation Behavior

According to one exemplary implementation, navigation among child UIpanes is accomplished with the directional remote keys (e.g., provided by the remote controller 116). For example if the down key is pressed, the nearest child below the active child UIpane will receive focus. If a directional key event is not handled, the parent UIpane attempts to pass focus to one of its siblings.

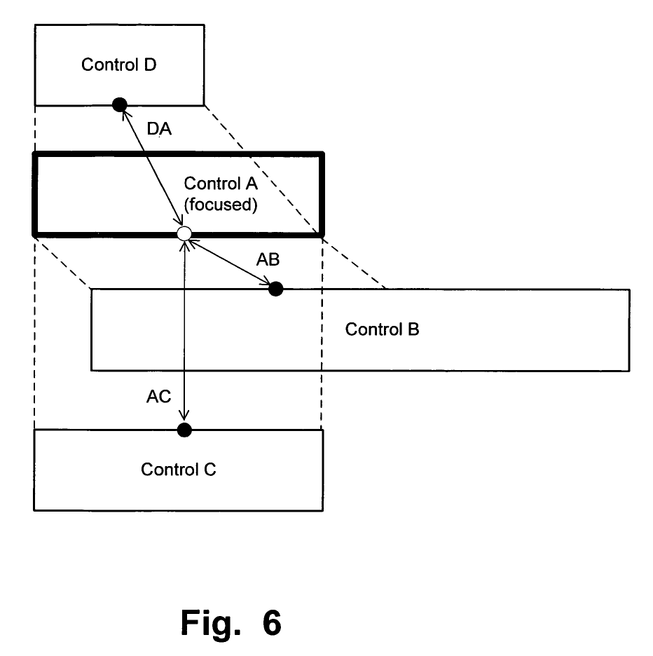

More specifically, the navigation is determined by “hot points” created on various locations of a UIpane. The location of a hot point depends on which arrow key is selected. For example, in FIG. 6, assume that control A currently has focus. If the down key is selected, the hot point of the current focused control will correspond to the middle of control A's lower edge. This hot point is then projected onto the top edge of each of the surrounding controls. The distance between each hot point pair is then measured. The pair with shortest positive distance determines the next control to receive focus. In this case, the hot point distance between controls A and B (line AB) is shorter than the hot point distance between controls A and C (AC), so that control B will receive focus next. (D is not considered because it is located completely above A).

A special case occurs when two controls are overlapping. For example, if control D overlaps control A such that control D's top edge is over control A, then control D will be considered on a down key press. Therefore, in this case, control D will receive focus if line AD is shorter than both lines AB and AC.

B.6. Graphics Features

A principal objective of the graphics-related functionality is to provide an API set that meets a developer's requirements as economically and efficiently as possible (in view of the limitations of a resource-constrained environment).

According to one general feature, the above objective is achieved, in part, by using an API set that is simplified (compared to a “full” API set provided in the desktop environment). For example, simplified graphics APIs are provided, such as line and ellipse drawing algorithms. The API set is also be flexible, to allow future expansion.

According to another feature, the graphics functionality directly interacts with the set-top box hardware, utilizing the processing power of the hardware as much as possible. For example, in the current system, the drawing primitives can directly write to the hardware. In contrast, conventional graphics APIs are overly-abstracted behind “heavy” desktop APIs (and therefore would become sluggish when applied in a resource-constrained set-top box environment).

More specifically, the graphics functionality can preset the code path so that calls are made, if possible, to the set top box 102's hardware APIs. To provide one example, the DCT 2000 set-top box hardware provides a block copy function which operates very quickly. However, this function requires that the source and destination pointers be WORD-aligned. The graphics functionality accommodates the requirements of this function and then calls it. As another example, the M68000 chip has a special feature referred to as DBRA. The graphics functionality can accommodate the requirements of this chip (e.g., alignment) and then can call this chip directly to provide very fast memory transfer.

As another example, the graphics functionality can also leverage the line control register (LCR) 210 of the set top box 102 to provide various special effects in an efficient manner. For example, suppose that the screen resolution is 480 lines. A developer can allocate 480 storage locations in the LCR 210 that point to respective lines of the data on the screen. Namely, this can be achieved by allocating a memory bitmap buffer for the entire on-screen display. In a normal state, each LCR storage location points to the beginning of each line of the bitmap. Special effects can be achieved by manipulating the order of the lines using the LCR 210 according to various algorithms. To take a simple case, if let LCR[10] points to line 9 in the bitmap and LCR[9] points to line 10 in the bitmap, then the set top box 102 will display these two lines in transposed order.

More specifically, exemplary unique graphics features of the set-top box system described herein include transition effects, custom palette support, blt rending functionality, true type font rendering, and so forth. These features are described in greater detail below. The Appendix, Section D, provides more details on these features.

B.6.1. Transition Effects

The set-top box 102 provides a number of transition effects that take effect when switching from one graphical presentation to another. The following functions provide exemplary transition effects. Again, these functions can be implemented by directly manipulating the LCR 210 in the manner described above.

A Scroll method scrolls the screen up if the an “offset” parameter specified in the method is a positive number, or down if the “offset” is a negative number. This effect will be provided within the bounds defined by “upBound” and “lowBound” parameters specified in the method.

A Decimate method simulates a decimation effect. More specifically, this method takes a percentage number as input to indicate the effect level. The decimation effect is provided between the “upBound” and “lowBound” parameters specified in the method.

A RasterFade method simulates a raster fade effect. This method takes a percentage number as input to indicate the effect level. The decimation effect is provided between the “upBound” and “lowBound” parameters specified in the method.

An Expose method exposes a number of lines, specified by an “linesToExpose” parameter specified in the method, in the center of the UIpane-specified “upBound” and “lowBound.”

B.6.2. Palette and Resolution Effects

The set-top box system allows a developer to dynamically change resolution and color palette. This can provide a more varied, and therefore a more interesting, user experience. For example, a developer can configure the system such that switching from a first application to a second application will prompt the system to potentially change color palette and resolution (corresponding to the second application).

To achieve the above effects, the system provides a SetUserPalette method. This method lets the user specify a custom palette to be associated with a graphics object.

In addition, a RestoreDefaultPalette method restores the default on-screen color palette.

A SetOSDResolution method allows the caller to set the on-screen display resolution.

A RestoreDefaultOSDResolution method restores the default on-screen display resolution.

B.6.3. Blt Effects

A BitBlt method blts contents from one graphics object to another graphics object. With this functionality, application developers, especially game programmers, can copy one part of the graphics context to another.

B.6.4. Font Rendering Functionality

As a general font processing feature, the set-top box system can strip unnecessary information from the font to provide more efficient processing of the fonts in the set-top box environment. Namely, a FontOptimizer tool optimizes font files by eliminating characters outside of the codeset file, remapping characters and stripping out glyph information to minimize file size. This feature therefore contributes to the general goal of running interesting applications in resource-constrained environments.

A SetAntiAliasBackgroundColor method sets a color to be used for anti-aliasing. More specifically, this call establishes a color used to build a table of intermediate colors for use in anti-aliasing.

A SetFont method sets a current font to be used for string draw operations.

A DrawString method draws a string in a specified color in a specific manner that is governed by its various parameters (e.g., note the Appendix for additional information).

A BreakString method, using a currently set font, attempts to break a string into words.

A GetFontMetrics method fetches the properties of a currently specified font used to provide accurate layout of text.

C. Exemplary Method of Operation

FIG. 7 describes the operation of the set-top box system in flowchart form. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the example set forth in this disclosure. As the functions described in this flowchart have already been explained in prior sections, Section C will serve primarily as a brief review of those functions.

In set 702, the set-top box 102 launches and loads an application using the above-described Initialize method. This prompts the set-top box 102 to establish a message thread for the application.

In step 704, the set-top box 102 pauses and then resumes the application as necessary during the running of the application. For example, the set-top box 102 can pause a current application if another application produces a UIpane that takes precedence over the current application. The set-top box performs memory management during the running of the program in the manner described above by removing stale objects.

In step 706, the set-top box 102 exits/terminates the application.

D. Appendix

The following section provides a more exhaustive listing of the various functions identified in previous sections.

D.1. The IUIpane Interface

The shell defines a base IUIpane interface that serves as a root base for all UIpanes. This interface allows the UIpane manager 312 to control all of the UIpanes without knowing the specifics of the implementation of each UIpane. The IUIpane interface can be expressed formally as: public interface IUIpane.

A IUIpane interface can provide the following exemplary and non-exhaustive list of interface functions:
A Graphics CreateGraphics( ) method obtains a graphics object for the UIpane.
A void Hideo method makes the UIpane invisible.
A void NotifyOnClose( ) method is invoked by the shell to notify a UIpane that it has been closed.
A void NotifyOnFocus(bool focus) is invoked by the shell to notify a UIpane that it has either gained or lost focus. The parameter “focus” is a value which indicates if the UIpane has gained or lost focus.
A void NotifyOnKey(int keyCode, ref bool handled) method is invoked by the shell to notify the currently active UIpane of a user input event. The UIpane will then appropriately route the event to its currently active child.
A void NotifyOnPaint(Rectangle rectangle) method is invoked by the shell to notify the currently active UIpane of a paint event. In this method, the parameter “rectangle” refers to the “dirty” region of the active UIpane. It is the responsibility of the active (parent) UIpane to send paint notifications to all of its children.
A void SetPaintThrottling(bool on) method turns paint throttling on or off.
A void Show( ) method makes the UIpane visible.

D.2. ABC_Co.TV.Lite.UIpanes

D.2.1. ABC_Co.TV.Lite.UIpanes Namespace Overview

By way of overview, the ABC_Co.TV.Lite.UIpanes namespace contains classes for creating “light TV applications” that are optimized for execution on low-end set-top boxes. As explained in previous sections, the set-top boxes run a provider's interpreter-based CLR system.

The classes in this namespace can be grouped into the following categories:
A UIpaneBase class category provides the base functionality for all UIpane controls that are displayed on a TV application. Most classes within the ABC_Co.TV.Lite.UIpanes namespace derive from the UIpaneBase class. The UIpaneBase class is also a container, meaning that it can contain child UIpanes.
A UIpane Forms class category allows for the creation of top level container UIpanes.
A UIpane Controls class category allow for the creation of user interfaces. For example, the Button class is a UIpane control.

There are a number of classes within the ABC_Co.TV.Lite.UIpanes namespace that provide support for the class categories mentioned in the preceding summary. FIG. 4 shows an exemplary hierarchical organization of these classes.

By way of overview, as to classes:
A Button class represents a TV button control.
A Control class defines the base class for controls. A control object defines an object with visual representation that performs a specific function.
A Form class defines the base class for parentless, top level, container UIpanes. Objects produced by this class (form objects) have some or no visual representation, and can contain child UIpanes.
A Transition class defines methods to apply a transition to a form object.
A UIpaneBase class is an abstract class that defines the base class for a UIpane (which defines an object with visual representation or an object that contains other UIpaneBase objects).

As to delegates:
A UIpaneEventHandler class represents the methods that will handle any UIpane event.
A KeyEventHandler class represents the methods that will handle key events.
A TransitionEventHandler class represents the methods that will handle a transition event.

As to enumerations:
A Keys class represents all possible keys codes used in a TV application.
A ButtonStyle class represents all possible button styles.

The following subsections provide additional details regarding each of the above-identified features of the ABC_Co.TV.Lite.UIpanes namespace.

D.2.2. ABC_Co.TV.Lite.UIpanes.UIpaneBase

As summarized above, the ABC_Co.TV.Lite.UIpanes.UIpaneBase class (UIpaneBase class) refers to an abstract base class for a UIpane (where a UIpane defines an object with visual representation or an object that contains other UIpaneBase objects). Namely, the UIpaneBase class implements very basic functionality required by classes that display information to the user. For instance, it defines the bounds of a UIpane, manages child UIpanes and handles user input through key events. It can be expressed formally as: public abstract class UIpaneBase: IUIpane.

As to the topic of layout, the UIpaneBase class is a container, meaning that it can hold any non-top level UIpanes. UIpanes can be added and removed from the container by calling Add, Insert, Remove, and RemoveAt on its children collection. A UIpane's top, left, width and height values are set during the creation of the UIpane. All children should be within the bounds of a parent UIpane. A user's input key events will first go to the focused UIpane. If the UIpane does not handle the key event, the event will be passed to its parent UIpane.

The navigation behavior enabled by the UIpaneBase class was described above (e.g., in Subsection B.5.2).

As to the topic of painting, the UIpaneBase class does not implement painting. That is, in one exemplary implementation, the developer is responsible for all painting, including the background. The developer can override an OnPaint method to perform painting. However, UIpaneBase will paint any child control within its children collection.

The UIpaneBase class can provide the following exemplary and non-exhaustive list of public constructors:
A public UIpaneBase(int left, int top, int width, int height, bool topLevel) constructor initializes a new instance of UIpaneBase class with specific location and size. Exception is thrown if the UIpane is outside the bounds of the screen. In this constructor, the parameter “left” refers to a distance, in pixels, between the left edge of the UIpane and the left edge of its container's client area. The minimum is 0 and the maximum corresponds to the OSD width. If the value is outside these bounds, an exception is thrown. The “top” parameter refers to the distance, in pixels, between the bottom edge of the UIpane and the top edge of its container's client area. The minimum is 0 and the maximum corresponds to the OSD height. If the value is outside these bounds, an exception is thrown. The “width” parameter refers to the width, in pixels, of the UIpane. The minimum is 1 and the maximum corresponds to the OSD width minus the left parameter. If the value is outside these bounds, an exception is thrown. The “height” parameter refers to the height, in pixels, of the UIpane. The minimum is 1 and the maximum corresponds to the OSD height minus the top parameter. If the value is outside these bounds, an exception is thrown. Finally, the “topLevel” parameter indicates whether the object is a top level UIpane.

The UIpaneBase class can provide the following exemplary and non-exhaustive list of public properties:
A public virtual byte BackColor property gets or sets the background color index for the UIpane. The exemplary default is 224.
A public virtual bool CanFocus property gets a value indicating whether a UIpane can receive focus.
A public ArrayList Children property gets the collection of UIpanes contained within a UIpane.
A public bool Enabled property gets or sets a value indicating whether the UIpane can respond to user interaction. Default is true. This property returns false if the UIpane is not the top level UIpane and does not have a parent or grandparent that is a top level UIpane.
A public bool Floating property gets or sets a value indicating whether the top level UIpane is a floating UIpane. A floating UIpane is a top level UIpane that will pass keys onto other top level UIpanes. Non-top level UIpanes cannot be floating UIpanes. Attempts to set the Floating property for non-top level UIpanes will be ignored.
A public bool Focused property gets a value indicating whether the UIpane has the input focus.
A public virtual byte ForeColor property gets or sets the foreground color index for the UIpaneBase. The exemplary default is 227.
A public int Height property gets the height of the UIpane.
A public int Left property gets the distance, in pixels, between the left edge of the UIpane and the left edge of its container's client area.
A public virtual IUIpane Parent property gets or sets the parent container of the UIpane. Exception is thrown if UIpane is outside of the parent's bounds. Top level UIpanes cannot have parents.
A public int Top gets the distance, in pixels, between the bottom edge of the UIpane and the top edge of its container's client area.
A public bool Visible property gets a value indicating whether the UIpane is displayed. Default is false for top level UIpanes, and true for all other UIpanes. This property returns false if the UIpane is not top level and does not have a parent or grandparent that is a top level UIpane.
A public int Width property gets the width of the UIpane.

The UIpaneBase class can provide the following exemplary and non-exhaustive list of public methods:
A public Graphics CreateGraphics( ) method creates a graphics object for the UIpane. It returns the graphics object for the UIpane.
A public bool Focus( ) method sets input focus to the UIpane. By default, the control does not have focus. Setting focus to a UIpane removes focus from any previously focused UIpane. Setting focus is asynchronous, so the UIpane will not actually obtain focus right away. This method returns “true” if the input focus request is successful; otherwise, “false.” Note, returning true means that the UIpane is able to notify the UIpane manager 312 that it is interested in obtaining focus. It does not mean that the UIpane has already obtained focus; it is up to the UIpane manager 312 to provide focus.
A public void Hideo method conceals the UIpane from the user.
A public void Invalidate(Rectangle region) method invalidates a specified region of the UIpane (that is, this method adds the region to the UIpane's update region, which is the area that will be repainted upon the next paint operation) and causes a paint message to be sent to the UIpane. Also, this method invalidates the child UIpanes assigned to the UIpane. In this method, the “region” parameter refers to the region to be invalidated. If the region parameter is null, the entire UIpane is invalidated.
A public void Refresh( ) method forces the UIpane to invalidate its client area and immediately redraw itself and any child UIpanes.
A public void Show( ) method displays the UIpane to the user.
A public void SuspendLayout(bool suspend) method temporarily suspends or resumes the layout logic for the UIpane. In this method, the “suspend” parameter indicates whether layout should be suspended.

The UIpaneBase class can provide the following exemplary and non-exhaustive list of public events:
A public event UIpaneEventHandler EnabledChanged occurs when the Enabled property value has changed.
A public event UIpaneEventHandler FocusChanged occurs when the UIpane input focus changes.
A public event KeyEventHandler KeyPress occurs when a key is pressed while UIpane has focus.
A public event UIpaneEventHandler VisibilityChanged occurs when the UIpane's visibility has changed.

The UIpaneBase class can provide the following exemplary and non-exhaustive list of protected methods:
A protected virtual void OnEnabledChanged( ) method raises an EnabledChanged event.
A protected virtual void OnFocusChanged( ) method raises a FocusChanged event.
A protected virtual void OnKeyPress(Keys keyCode, ref bool handled) method raises a KeyPress event. In this method, the “keyCode” parameter refers to a key code to be used by the key event. The “handle” parameter refers to a value indicating whether the key event has been handled.
A protected virtual OnPaint(Graphics graphics, Rectangle clipRectangle) method provides a base paint method. Namely, this method paints children within the clipRectangle. That is, the “clipRectangle” parameter refers to a region to be painted. Everything is painted if clipRectange is null. The “graphics” parameter refers to the graphics used to perform the painting. An exception is thrown if graphics is null.
A protected virtual OnVisibilityChanged( ) method raises a VisibilityChanged event.

D.2.3. ABC_Co.TV.Lite.UIlanes.Form

The ABC_Co.TV.Lite.UIpanes.Form class (Form class) derives from the above-described UIpaneBase class. The Forms class defines the base class for parentless, top level, container UIpanes. These objects have some or no visual representation, and can contain child UIpanes. More specifically, interpreter-based CLR applications can use forms for the main and other top level UIpanes. An application may contain more than one form; however, each form must be registered with the application. The main UIpane is registered automatically when calling Run; however, subsequent top level UIpanes (or forms) must be expressly registered in order to receive key and paint events. The Form class can be formally expressed as: public class Form: UIpaneBase

The Form class can provide the following exemplary and non-exhaustive list of public constructors:
A public Form( ) constructor initializes new instances of the Form class with default settings. By default, a form is the same size as the OSD.
A public Form(int left, int top, int width, int height) constructor initializes a new instance of the Form class with a specific location and size. An exception is thrown if the UIpane is outside the bounds of the screen. The left, top, width and height parameters were described above (in the context of the UIpaneBase class).

The Form class can provide the following exemplary and non-exhaustive list of public methods:
A public void Close( ) method closes the form. When the form is closed, all resources created within this object are closed and the form is disposed of.
A public bool DoTransition( ) method raises a transition event. If the form is overlapping any other form, then a transition event cannot be raised. Before an event is raised, the screen is locked at the horizontal region used by the form. While locked, no other forms can be created or moved to the locked region. This method returns “true” if the event was raised, and “false” otherwise.

The Form class can provide the following exemplary and non-exhaustive list of public events:
A public event UIpaneEventHandler Closed occurs when the form is closing.
A public event TransitionEventHandler Transition occurs when DoTransition( ) is invoked.

The Form class can provide the following exemplary and non-exhaustive list of protected methods:
A protected virtual void OnClosed( ) method raises the Closed event.

D.2.4. ABC_Co.TV.Lite.UIpanes.Control

ABC_Co.TV.Lite.UIpanes.Control class (Control class) derives from UIpaneBase. This class defines the base class for controls. A control is an object with visual representation that performs a specific function. For example, interpreter-based CLR applications use controls for their user interface elements. An example of a control is an object derived from the Button class. The Control class can be formally expressed as: public class Control: UIpaneBase.

The Form class can provide the following exemplary and non-exhaustive list of public constructors:
A public Control(int left, int top, int width, int height) constructor initializes a new instance of Control class with specific location and size. An exception is thrown if the control is outside the bounds of the screen. The left, top, width and height parameters were described above (in the context of the UIpaneBase class).

The Control class can provide the following exemplary and non-exhaustive list of public methods:
A public void BringToFront( ) method brings the UIpane to the front of the z-order. The z-order is determined by an index within the parent's children collection. The greater the index, the closer to the front; that is if the index is 0, then the child appears in the rear.
A public void SendToBack( ) method sends the UIpane to the back of the z-order.

D.2.5. ABC_Co.TV.Lite.UIpanes.Button

The ABC_Co.TV.Lite.UIpanes.Button class (Button class) derives from the Control class. The Button class represents a TV button control. That is, a button can be clicked by using the TV remote's OK key if the button has the input focus. A button can also contain children; however, these children will not be painted. The button's appearance can be set using the Style property (see ButtonStyle). For example, to produce a button with a left-rounded edge and text left-aligned, Style can be set equal to ButtonStyle.RoundedLeft|ButtonStyle.LeftAligned. The Button class can be formally expressed as: public class Button: Control

The Button class can provide the following exemplary and non-exhaustive list of public constructors:
A public Button(int left, int top, int width, int height) constructor initializes a new instance of Button class with specific location, size or style. The left, top, width and height parameters were described above (in the context of the UIpaneBase class).

The Control class can provide the following exemplary and non-exhaustive list of public properties constructors:
A public override byte BackColor property gets or sets the background color index for the UIpane. The exemplary default is 224.
A public byte BorderColor property gets or sets the border color index for the UIpane. The exemplary default is 227.
A public uint BorderWidth property gets or sets the border width, in pixels, for the button. The exemplary default is 4.
A public override byte ForeColor property gets or sets the foreground color index for the UIpane. The exemplary default is 227.
A public byte SelectedBorderColor property gets or sets the selected border color of the button. The exemplary default is 211.
A public ButtonStyle Style property gets or sets the value representing the button style. The exemplary default value is 0x3, with all rounded edges and text center-aligned.
A public String Text property gets or sets the value representing the text label of the button. If Text is set to null, Text is set to an empty string. The exemplary default is an empty string.

The Button class can provide the following exemplary and non-exhaustive list of public methods.
A public virtual void GetFont(out string name, out int height, out int aspect) gets the font parameters of the button text. The “name” parameter refers to the font name of the button text. The exemplary default for name is “Tiresias” (although, of course, the default name can be set to any name). The “height” parameter refers to the font height of the button text. The exemplary default value height is 20. The “aspect” parameter refers to the font aspect ratio of the button text. The exemplary default value for aspect is 100.
A public virtual void SetFont(string name, int height, int aspect) method sets the font parameters of the button text. The exemplary default values are as stated above.

The Button class can provide the following exemplary and non-exhaustive list of public events:
A public event UIpaneEventHandler Click occurs when the button is clicked.

The Button class can provide the following exemplary and non-exhaustive list of protected methods:
A protected virtual void OnClick( ) method raises the Click event.
A protected override void OnKeyPress(Keys keyCode, ref bool handled) method raises the KeyPress event. In this method, the “keyCode” parameter describes the key code to be used by the key event. The “handle” parameter provides a reference to a value which indicates whether the key event has been handled.
A protected override void OnPaint(Graphics graphics, Rectangle clipRectangle) method paints the button and raises the paint event. In this method, the graphics parameter refers to the graphics used to paint. An exception is thrown if graphics is null. The “clipRectangle” parameter refers to the region to be painted. Everything is painted if clipRectange is null.
A protected virtual void OnPaintBackground(Graphics graphics) method draws the background of the button. The developer may want to draw their own background (e.g., to draw a fancy bitmap). In these cases, the developer can override this method. In this method, the “graphics” parameter refers to the graphics used to paint. An exception is thrown if graphics is null.
A protected override OnVisibilityChanged( ) method raises the VisibilityChanged event.

D.2.6. ABC_Co.TV.Lite.UIpanes.UIpaneEventHandler

The UIpaneEventHandler class represents the methods that will handle UIpane events. This class can be formally expressed as: public delegate void UIpaneEventHandler(object sender). The declaration of the event handler should have the same parameters as the UIpaneEventHandler delegate declaration. In this class, the “sender” parameter refers to the source of the event.

D.2.7. ABC_Co.TV.Lite.UIpanes.KeyEventHandler

The KeyEventHandler class represents the methods that will handle key events. This class can be formally expressed as: public delegate void KeyEventHandler(object sender, Keys keyCode, ref bool handled). The declaration of the event handler should have the same parameters as the KeyEventHandler delegate declaration. The “sender” parameter refers to the source of the event. The “keyCode” parameter refers to the key code of the key event. The “handled” parameter indicates whether this key event has already been handled.

D.2.8. ABC_Co.TV.Lite.UIpanes.Transition

The Transition class provides methods to apply a transition to the screen. More specifically, the Transition class can be use to provide visual transitions to a form object. To create a transition object, the developer can first raise a transition event by invoking Form.DoTransition( ). This API will lock a specified horizontal screen area and raise a transition event. The developer can then create an event handler to handle the transition event. This event handler will then receive a valid transition object. The Transition class can be formally expressed as: public class Transition.

### EXAMPLE

```
public class MyForm : Form
{
        public MyForm( ) : base( )
        {
            // Create a new event handler
            this.Transition += new
            TransitionEventHanlder(this.OnTransition);
        }
        public void Start( )
    {
        // Raise transition event
        this.DoTransition( );
        }
    public void OnTransition(object sender, Transition transition)
    {
        // Perform transition effects.
    }
}
```

The Transition class can provide the following exemplary and non-exhaustive list of public properties:
A public int Height property gets the height of the Transition object.

The Transition class can provide the following exemplary and non-exhaustive list of public methods:
A public void Decimate(int numerator, int denominator, int offset, int top, int bottom) method simulates a decimate effect on the transition object. The numerator and denominator represent the percentage of lines between top and bottom that will be affected. That is, percentage=(numerator/denominator)*100. In this method, the parameter “numerator” represents the numerator of the percentage value. The parameter “denominator” represents the denominator of the percentage value. The parameter “offset” represents the number of lines (in pixels) from the top that will remain unaffected by the decimation. The parameter “top” refers to the top of the area to be considered when decimating. The upper bound is relative to the transition object. An exception is thrown if the argument is out of range. The “bottom” parameter refers to the bottom of the area to be considered when decimating. The lower bound is relative to the transition object. An exception is thrown if the argument is out of range.
A public void Expose(int linesToExpose, int top, int bottom) method exposes a number of lines, specified by linesToExpose, in the center of the area defined by top and bottom. That is, the parameter “linesToExpose” refers to a number of lines to expose from the center of the area defined by the specified top and bottom. The parameter “top” refers to the top of the area to be considered when exposing the lines. The upper bound is relative to the transition object. Exception is thrown if the argument is out of range. The parameter “bottom” refers to the bottom of the area to be considered when exposing the lines. The lower bound is relative to the transition object. An exception is thrown if the argument is out of range.
A public void RasterFade(int numerator, int denominator, int top, int bottom) method simulates a raster fade effect on the transition object. The numerator and denominator represent the percentage of lines between top and bottom that will be affected. That is, percentage=(numerator/denominator)*100. The parameter “numerator” represents the numerator of the percentage value. The parameter “denominator” represents the denominator of the percentage value. The parameter “top” refers to top of the area to be raster-faded. The upper bound is relative to the transition object. An exception is thrown if the argument is out of range. The parameter “bottom” refers to the bottom of the area to be raster-faded. The lower bound is relative to the transition object. An exception is thrown if the argument is out of range.
A public void Scroll(int offset, int top, int bottom) method scrolls the area defined by top and bottom either up or down. The parameter “offset” refers to an offset indicating the number of lines to scroll. If value is greater than 0, then the area is scrolled up; otherwise, the area is scrolled down. The parameter “top” refers to the top of the area to be scrolled. The upper bound is relative to the transition object. An exception is thrown if the argument is out of range. The parameter “bottom” represents the bottom of the area to be scrolled. The lower bound is relative to the transition object. An exception is thrown if the argument is out of range.

D.2.9. ABC_Co.TV.Lite.UIpanes.TransitionEventHandler

The TransitionEventHandler class represents the methods that will handle transition events. The declaration of the event handler should have the same parameters as the TransitionEventHandler delegate declaration. This class can be formally expressed as: public delegate void TransitionEventHandler (object sender, Transition transition). The parameter “sender” refers to the source of the event. The parameter “transition” refers to the transition object.

D.2.10. ABC_Co.TV.Lite.UIpanes.ButtonStyle

This enumeration specifies the available button styles. More specifically, ButtonStyle specifies the appearance of a Button object. If a button style is equal to 0x0, then the Button object has no curved edges and the text is aligned to the left. If neither LeftAligned nor RightAligned are set, then the text is center-aligned. If both LeftAligned and RightAligned are set, then LeftAligned takes precedence. If neither RoundedLeft nor RoundedRight are set, then the Button object has no curved edges. The ButtonStyle enumeration can be formally expressed as: public enum ButtonStyle

Other exemplary members in this enumeration are specified in the following table:

TABLE 1
ButtonStyle Members

| Member name | Description | Value |
|---|---|---|
| LeftAligned | The text is aligned to the | 0x8 |
| | left. | |
| RightAligned | The text is aligned to the | 0x4 |
| | right. | |
| RoundedLeft | The left edge is rounded. | 0x1 |
| RoundedRight | The right edge is rounded. | 0x2 |

D.2.12. ABC_Co.TV.Lite.UIpanes.Keys

This enumeration specifies the key codes. Each key is identified by a key value, which consists of a virtual key code. This enumeration can be formally expressed as: public enum Keys.

Exemplary members in this enumeration are specified in the following table:

TABLE 2
Keys Members

| Member name | Description | Value |
|---|---|---|
| ByPass | The by pass button. | 426 |
| ChannelDown | The channel down button. | 412 |
| ChannelUp | The channel up button. | 413 |
| DayBackward | The day backward button. | 0xB2 |
| DayForward | The day forward button. | 0xFA |
| Down | The down arrow button. | 0x28 |
| Enter | The enter button. | 0x10 |
| Exit | The exit button. | 0x1B |
| Fastforward | The fast frwd button. | 458 |
| Favorites | The favorites button. | 495 |
| Guide | The guide button. | 465 |
| Help | The help button. | 0x2F |
| Info | The info button. | 468 |
| Last | The last button. | 401 |
| Left | The left arrow button. | 0x25 |
| List | The list button. | 433 |
| Live | The live button. | 434 |
| Lock | The lock button. | 425 |
| Menu | The menu button. | 0x12 |
| Music | The music button. | 0xD |
| Mute | The mute button. | 0xAD |
| NewPlay | The new play button for | 430 |
| | 600/800 remotes. | |
| NewStop | The new stop button for | 431 |
| | 600/800 remotes. | |
| PageDown | The page down button. | 0x22 |
| PageUp | The page up button. | 0x21 |
| Pause | The pause button. | 0x13 |
| Play | The play button. | 0xFA |
| Power | The power button | 489 |
| Record | The record button. | 499 |
| Remote0 | The 0 remote button. | 0x30 |
| Remote1 | The 1 remote button. | 0x31 |
| Remote2 | The 2 remote button. | 0x32 |
| Remote3 | The 3 remote button. | 0x33 |
| Remote4 | The 4 remote button. | 0x34 |
| Remote5 | The 5 remote button. | 0x35 |
| Remote6 | The 6 remote button. | 0x36 |
| Remote7 | The 7 remote button. | 0x37 |
| Remote8 | The 8 remote button. | 0x38 |
| Remote9 | The 9 remote button. | 0x39 |
| RemoteA | The A remote button. | 422 |
| RemoteB | The B remote button. | 423 |
| RemoteC | The C remote button. | 424 |
| Replay | The replay button. | 432 |
| Rewind | The rewind button. | 501 |
| Right | The right arrow button. | 0x27 |
| Select | The ok/select button. | 400 |
| Stop | The stop button. | 0xB2 |
| Up | The up arrow button. | 0x26 |
| VOD | The video on demand | 429 |
| | button. | |
| VolumeDown | The volume down button. | 0xAE |
| VolumeUp | The volume up button. | 0xAF |

D.3. ABC_Co.TV.Lite.Shell.TVLiteApplicationBase

The ABC_Co.TV.Lite.Shell namespace contains, among other things, an abstract TVLiteApplicationBase class for creating light TV applications. That is, the ABC_Co.TV.Lite.Shell.TVLiteApplicationBase (ApplicationBase class) represents a TV application. All interpreter-based CLR applications should derive from the abstract TVLiteApplicationBase interface and provide the required implementation. The ApplicationBase class can be formally expressed as: public abstract class TVLiteApplicationBase.

The ApplicationBase class can provide the following exemplary and non-exhaustive list of protected methods:
A protected void Run(IUIpane mainUIpane) method begins running a standard application message loop on a current thread, and makes the specified UIpane visible. In a compact .NET environment, the run method is a static method. However, static methods in an interpreter-based CLR environment are global to all running threads. Therefore, the Run method is implemented as a protected method in the abstract base class TVLiteApplicationBase to allow each application to have its own message pump.

The Run method will automatically call RegisterUIpane to register the main UIpane as a top level UIpane. Namely, the parameter mainUIpane refers to a UIpane that will be made visible.

The ApplicationBase class can provide the following exemplary and non-exhaustive list of public properties:
A pubic bool EnhancedGraphicsMode property allows an application to enter into “Enhanced Graphics Mode (EGM).” The EGM mode allows an application to set user palette, change OSD resolution, and so forth. It is an exclusive mode, so that when an application requests to enter the EGM mode (setting the EnhancedGraphicsMode to true), all other managed application will be suspended. An application that enters the EGM mode should set EnhancedGraphicsMode to false when it wants to leave the EGM mode so that other suspended managed applications can run. The application manager 310 will force an application to leave the EGM mode when the application is exiting. The default value of this property is set to false. This property can only be set to true prior to a call to the Run method. An exception will be thrown if this property is set to true after the Run method is called to start the message loop.

The ApplicationBase class can provide the following exemplary and non-exhaustive list of public methods:
A pubic abstract void Initialize(string url) method performs application-defined initialization. The URL of the HTTP request to launch the application along with the parameters that are appended to the URL will be passed to the application via the url parameter in the call to Initialize. The following provides an exemplary url parameter:

http://appserver/monster.dat?param1=value1&param2=value2.

The application will be terminated if the application generates an unhandled exception.

A public void Exit( ) method informs all message pumps that they must terminate, and then closes all application UIpanes after the messages have been processed. The Exit method is typically called from within a message loop, and forces the Run method to return. The application manager 310 will not call the Terminate method because the application has called the Exit method to exit the application.
A public void RegisterUIpane(IUIpane topLevelUIpane) method allows an application to register its top level UIpanes with the UIpane manager 312. The UIpane manager 312 will dispatch UIpane events to the top level UIpane.
A public abstract void Pause( ) method allow the application manager 310 to send a pause event to the application to request it to pause. The application manager 310 will suspend the thread after requesting the application to pause. The application thread will be suspended even if the application generates an unhandled exception when handling a pause event.
A pubic abstract void Resume( ) method allows the application manager 310 to send a resume event to the application to request it to resume. The application manager 310 will un-suspend the application thread before calling the application to resume. The application thread will be unsuspended even if the application generates an unhandled exception when handling a resume event.
A public abstract void Terminate( ) method allows the application manager 310 to send a terminate event to the application to request it to terminate. The application manager 310 will terminate the application thread if the application thread is still running after returning from handling the terminate event. The application thread will be terminated even if the application generates an unhandled exception when handling a Terminate event.
A public abstract void ReleaseResource( ) method allows the application manager 310 to send a release resource event to the application to request it to release any resource that can be freed. This includes removing references to objects for the garbage collector.

D.4. ABC_Co.TV.Lite.Drawing Namespace

D.4.1. Overview

The ABC_Co.TV.Lite.Drawing (Drawing) namespace provides an API set that can be easily used by developers writing graphics applications on the set-top box platform using the interpreter-based CLR.

D.4.2. ABC_Co.TV.Lite.Drawing.Graphics Class

The Graphics class derives from the Drawing class. It can be expressed formally as: public class Graphics.

The Graphics class can provide the following exemplary and non-exhaustive list of public constructors:
A public Graphics(int x, int y, int width, int height) constructor provides a method that lets the caller create a graphics object at any location on the screen. The graphics object cannot go beyond the TV display area. If this happens, this constructor automatically clips the graphics being created to the valid TV display area.
A public Graphics(int width, int height) constructor provides a method that creates an off-screen graphics object in a memory buffer. In one exemplary implementation, the above two Graphics constructors can be provided as “internal” methods. This is because the programming model requires that all applications have a form object (derived from the Form class). The graphics object is controlled by the form object so that all drawings are in sync. For example, in the present application model, a button simply represents a rectangle inside the form, rather than a separate UIpane object in a conventional programming environment. The form object is responsible for painting the button. If the developer is allowed to create the graphics for this form, then it becomes difficult to sync the button and other contents which appear on the same form. (Recall that the form class will have a method CreateGraphics( ).)

The Graphics class can provide the following exemplary and non-exhaustive list of public properties:
A public Rectangle ClipBounds property is used for the clipping region that the current graphics object is working on.

The Graphics class can provide the following exemplary and non-exhaustive list of public methods:
A public void Dispose( ) method disposes of the graphics object.
A public void SetClip(Rectangle clipRect) method sets a clipping region in current graphics object.
A public void ResetClip( ) method resets the clipping region in the graphics object back to its default state
A public void SetUserPalette(uint[ ] punPalette, byte startPos) method lets the user specify a custom palette to be associated with the current graphics object. In one exemplary implementation, the maximum number of palette entries that the user can specify is 253. The user can also specify where the custom palette should start in the whole color palette array. If the number of colors in the custom palette plus the starting position for the custom palette is larger than 253, then an INVALID_PARAMETER exception will be thrown.

More specifically, in one exemplary implementation, a caller is not allowed to set the color index to 0 because this is reserved by the OS 304 to indicate transparent color. Also, the index 255 is used as an OSD transparent color index when the image format supported on this platform is encoded. The index 254 is used as the RLE escape key. Therefore, this index is prohibited as well. This explains, in this exemplary implementation, the reason why the number of colors in the custom palette cannot be larger than 253.

As a further note, in one exemplary implementation, this method can only be called when the graphics system is in an EGM mode. Otherwise, an “INVALID_EGM_STATE” exception will be thrown. Also, an “INVALID_INPUT_PARAMETER” will be thrown if the input parameter is not valid or the starting position is out of range.
A public static void RestoreDefaultPalette( ) method restores the default OSD color palette.
A public void SetOSDResolution(OSDResolution resolution) method lets the caller set the OSD display resolution.

In one exemplary implementation, the enum OSDResolution method is governed by the following definitions:

| | |
|---|---|
| { | |
| OSD_RES_704 = 0x0, | // 704×480 resolution |
| OSD_RES_576, | // 576×480 resolution |
| OSD_RES_448, | // 448×480 resolution |
| OSD_RES_352 | // 352×480 resolution |
| }; | |

In one exemplary implementation, this method can be only called when the graphics system is in the EGM mode; otherwise, an “INVALID-EGM-STATE” exception will be thrown.
A public void RestoreDefaultosDResolution( ) method restores the default OSD display resolution.
A public void SetPixel(int x, int y, byte colorIndex) method lets a user set a color value at a specified location on the graphics context.
A public byte GetPixel(int x, int y) method lets a user get the color index value at a specified location on the graphics context.
A public void FillRectangle(byte colorIndex, int x, int y, int width, int height) method fills a rectangle in with a specified color.
A public void DrawRectangle(byte colorIndex, int penwidth, int x, int y, int width, int height) method draws a rectangle with a specified color and pen width.
A public void FillEllipse(byte colorindex, int x, int y, int width, int height) method fills an ellipse in with a specified color.
A public void DrawEllipse(byte colorIndex, int penwidth, int x, int y, int width, int height) method draws an ellipse with a specified color and pen width.
A public void DrawLine(byte colorIndex, int penwidth, int startX, int startY, int endX, int endY) method draws a line with a specified color and pen width.
A public void FillRoundectangle(byte colorindex, int x, int y, int width, int height, int radius, RoundingStyle style) method fills a rectangle with rounded edges with a specified color. In this method, the “radius” parameter must be less than or equal to one half of the minimum of the “height” and “width” parameters. If the radius exceeds this value, it will be trucated to that limit. The “style” parameter can comprise: RoundingStyle.All; RoundingStyle.UpperLeft; RoundingStyle.UpperRight; RoundingStyle.LowerLeft; RoundingStyle.LowerRight; or an OR'd combination.
A public void DrawRoundRectangle(byte colorIndex, int lineWidth, int x, int y, int width, int height, int radius, RoundingStyle style) method draws a rounded rectangle outline of the specified thickness with the specified color. The “radius” parameter must be less than or equal to one half of the minimum of the “height” and “width” parameters. If the radius exceeds this value, it will be truncated to that limit. The “style” parameter can comprise: RoundingStyle.All; RoundingStyle.UpperLeft; RoundingStyle.UpperRight; RoundingStyle.LowerLeft; RoundingStyle.LowerRight; or an OR'd combination.
A public void BitBlt(int destX, int destY, int destWidth, int destHeight, Graphics srcGraphics, int srcX, int srcY) method blts contents from one graphics object to another graphics object.
A public void DrawImage(byte[ ] buffer, int x, int y) method draws a special format bitmap currently supported on the platform. The user can use provided tools to convert a regular image into this special format bitmap. An INVALID_IMAGE_FORMAT exception will be thrown if the image is not one of the formats that this platform supports.

The Graphics class can provide the following exemplary and non-exhaustive list of internal methods:
An internal Graphics( ) method provides a constructor which creates a graphics object that covers the whole TV display UIpane.
An internal static void EnterEGM( ) method allows an application to enter “Enhanced Graphics Mode” (EGM). In one exemplary implementation, only one application is allowed to enter EGM mode at any particular time. An “INVALID_EGM_STATE” exception will be thrown if the caller attempts to enter EGM mode when the graphics system is already in EGM mode. An application is allowed to set user palette, change OSD resolution, etc. only in EGM mode.
An internal static void LeaveEGM( ) method leaves EGM mode. Before calling this API, the caller is responsible for restoring the default color palette and default OSD resolution. An “INVALID_EGM_STATE” exception will be thrown from this API if: (1) the application is not in EGM mode; (2) the application has not restored the default color palette; or (3) the application has not restored the default OSD resolution.
An internal static void Scroll(int offset, int upBound, int lowBound) method scrolls the screen up if the “offset” is a positive number, or down if the “offset” is a negative number. This effect will only happen within the up/low bound.
An internal static void Decimate(int numerator, int denominator, int offset, int upBound, int lowBound) method simulates a decimation effect. It takes a percentage number as input to indicate the effect level.
An internal static void RasterFade(int numerator, int denominator, int upBound, int lowBound) method simulates a raster fade effect. It takes a percentage number as input to indicate the effect level.
An internal static void Expose(int linesToExpose, int upBound, int lowBound) method exposes a number of lines, specified by “linesToExpose,” in the center of the UIpane-specified “upBound” and “lowBound”.

D.4.3. RLE Compressed Image Format Used in ABC_Co.TV.Lite

The platform can use a variety of image formats. Two kinds of proprietary image formats include: an uncompressed bitmap format; and an RLE compressed bitmap format. These proprietary image formats can be generated using an image conversion tool which can be supplied to the customers.

A description of the RLE compressed format follows.

| | |
|---|---|
| typedef struct | |
| { | |
| unsigned char ucMagic1; | // First file signature number: “V” |
| unsigned char ucMagic2; | // Second file signature number: “J” |
| unsigned char fRLE; | // 1 if the image is RLE compressed |
| unsigned char ucPad; | // Padding, unused |
| unsigned short usWidth; | // Width of the image |
| unsigned short usHeight; | // Height of the image |
| } SpotImageHeader; | |

If less than two consecutive pixels have the same pixel value, this format encodes the current pixel “as is.” If more than two consecutive pixels are encountered that have the same value, this format encodes these pixels as an RLE sequence, which is: RLE_ESCAPE, pixel (index) value and counter.

D.5. Font Methods

The following subsection sets forth functionality for handling the rendering of fonts.

D.5.1. Installing and Deinstalling Fonts

Font lifetime management is handled in the TVLiteApplicationBase object. Functionality for installing and optionally deinstalling fonts comprise:
A void TVLiteApplicationBase.InstallFont(string name, byte [ ] fontdata) method installs a new font. The font is stripped of unnecessary header information (compared to the use of such a font in a desktop environment). Font names are case sensitive.

This method throws an exception: (1) if a font of the same name is already installed but with different data; (2) if the supplied bytes cannot be parsed as a valid stripped true type font; or (3) for other typical error conditions. If a second attempt is made to install a font with identical data, the call will not throw an exception. That is, if the application installing the font is distinct from the application that originally installed the font, a reference count will be incremented for the font. If the same application installs the same font twice, the second installation attempt does not have effect.

The InstallFont method provides the following exemplary exception error returns:

0-(MAX_FONTS-1)=slot number for this font;

FONT_DUP_NAME=font of same name already installed but data does not match;

FONT_TABLE_FULL=font table full; and

FONT_DATA_VALIDATION_ERR=problem loading font data.

Note that other applications can use this same font while it is installed, but if they have not installed the font themselves, the font could disappear when the installing application exits. As such, it would be considered bad practice to “piggyback” on another application's installation unless it can be assured that the “host” application will not exit before the piggyback application.
A void TVLiteApplicationBase.DeinstallFont(string name) method deinstalls a font. Or, if more than one application has installed the font, the DeinstallFont method releases the reference count for the calling application.

More specifically, an installed font will persist for the life of the application and will automatically be removed when the application exits (if this exiting application is the last application using the font). It is usually not necessary to call DeinstallFont before exiting. However, if it is necessary to make only transient use of a font, a developer may consider explicitly deinstalling the font.

The DeinstallFont call will throw an exception if the application did not install the font or has already deinstalled the font.

D.5.2. Graphics Object Font-Related Methods

The graphics object provides a number of other font-related APIs (methods). Exemplary such methods include:
A void SetAntiAliasBackgroundColor(int backIndex) method sets the color to be used for anti-aliasing. More specifically, this call establishes a color used to build a table of intermediate colors to use for anti-aliasing purposes. This is very efficient when the default palette is being used and the foreground and background colors fall within a 6×6×6 color cube. An exhaustive walk of the color table will be performed when a custom palette is used or when colors are being used outside of the 6×6×6 space; the walk finds the best value for each position in the anti-aliasing table.

If a “backIndex” of −1 is specified, no anti-aliasing will be performed. Setting a background color that is identical to a foreground color being used has the effect of disabling the anti-aliasing.

Exemplary exception error returns include:

FONT_PARAM_OUT_OF_RANGE=palette index out of range; and

FONT_SYSTEM_ERR=error fetching system color palette info.
A void SetFont(string name, int height, int aspect) method sets the current font to be used for string draws. The “aspect” parameter defines a percent value between 30 and 250 inclusive, with 30 meaning 30% normal width and 25 meaning 250% normal width. The “height” parameter specifies the height in pixels of the font in the range 4-250 inclusive. The font name is case-sensitive. If the font is a glyph-only font (a font containing no cmap table), then the height and aspect are ignored.

Exemplary exception error returns include:

FONT_NOT_FOUND=no font at that slot; and

FONT_PARAM_OUT_OF_RANGE=param out of range.
A void DrawString(byte colorindex, string s, int x, int y) method draws a string in the specified color using the currently set font at location (x,y). This method performs no formatting; it just draws a single line of text.

Exemplary exception error returns include:

FONT_NOT_FOUND=no font at that slot; and

FONT-PARAM-OUT-OF-RANGE=size or aspect ratio out of range.
A void DrawString(byte colorindex, string s, int x, int y, int width, AlignStyle align, char truncation) method draws a string in the specified color using the currently set font, with left, right, or center alignment truncating if necessary so as not to exceed the specified width. If the string is truncated and a non-zero truncation character is supplied, this character is pre-pended or appended to the string. For a truncated centered string, the truncation character is both pre-pended and appended. In this method, the align parameter can be: AlignStyle.Left, AlignStyle.Right, or AlignStyle.Center.

Exemplary exception error returns include:

FONT_NOT_FOUND=no font at that slot; and

FONT-PARAM-OUT-OF-RANGE=size or aspect ratio out of range.
A void DrawString(byte colorindex, byte[ ] utf8 Bytes, int byteOffset, int characterCount, byte[ ] advances, int x, int y) method draws either a string or a run of glyphs depending on the currently selected font. If the selected font contains only glyphs (no cmap table), then the bytes starting at byteOffset from the head of the byte area are decoded and treated as glyph indices. Otherwise the bytes are treated as a UTF-8 encoded character run. The glyphs are drawn using the specified color index, and anti-aliased to the current anti-alias background color. An “advances array” contains the horizontal advances for each character/glyph to be drawn.

In order to support advances less than 0, advances are encoded in the following manner. Each character advance width is one or two bytes in length. Advance widths in the range 0 to 127 are stored without modification, using 1 byte. Outside this range, the most-significant bit (0x80) indicates the first byte of a two-byte sequence. The next bit (0x40) indicates whether the decoded value should be negated. Bits 4 and 5 (0x30) are ignored but should be set to 0. The lower 4 bits and the next byte represent the magnitude of the advance width. If bit 6 of the first byte is set, then the width is negated. This supports widths up to 12 bits in length. If an advance list is supplied, it must contain at least enough entries to support the number of characterCount characters.

Exemplary exception error returns include:

FONT_NOT_FOUND=no font is selected; and

FONT_PARAM_OUT_OF_RANGE=size or aspect ratio out of range.
An int MeasureString(string s) method returns the width of the string in pixels using the currently set font.

Exemplary exception error returns include:

FONT_PARAM_ERR=NULL inputs, etc.;

FONT_NOT_FOUND=no valid font selected;

FONT_PARAM_OUT_OF_RANGE=font size or aspect params out of range; and

FONT_BAD_UTF8_CODE=invalid UTF8 sequence in string.
An int BreakString(string s, int startIndex, int width, string sep) method, using the currently set font, attempts to break the string into words using the characters in “sep” and will return the index of the separator character when the string can be broken to fit the specified width. This method returns “1” if the string cannot be broken to fit within the supplied width using “sep.” For efficiency reasons, in one exemplary implementation, the “sep” string can only contain a maximum of 8 characters. This should be adequate for most practical purposes. If this string is the empty string, then the text will be broken on any character. For instance, assume that the string “How now brown cow” is passed with the separator string containing only a space character, startIndex of zero. If only the first three words will fit, BreakString( ) will return 13, the index of the space before “cow.” If the entire string fits, this method will return the length of the string, 17.

Exemplary exception error returns include:

FONT_PARAM_ERR=NULL parameter, etc.;

FONT_NOT_FOUND=no valid font selected;

FONT_PARAM_OUT_OF_RANGE=font size or aspect parameters out of range, sep string too long; and

FONT_BAD_UTF8_CODE=invalid UTF8 sequence in “sep” string.
A void GetFontMetrics(out int ascent, out int descent, out int lineSpacing) method fetches the properties of the currently specified font needed for accurate layout of text. The “ascent” parameter is a positive value describing how many pixels the font glyphs may draw above the baseline. The “descent” parameter is a positive value describing how many pixels the font glyphs may draw below the baseline. The “lineSpacing” parameter is the expected default spacing in pixels needed between lines of text in this font. This is the sum of the font's ascent, descent, and line gap.

Exemplary exception error returns include:

FONT_PARAM_ERR=NULL param, etc.; and

FONT_NOT_FOUND=not font at spec'd slot.

D.5.3. Font Error Codes

Exemplary font error codes include:

| | |
|---|---|
| FONT_PARAM_ERR | 0x85000002 |
| FONT_DUP_NAME | 0x85000003 |
| FONT_TABLE_FULL | 0x85000004 |
| FONT_DATA_VALIDATION_ERR | 0x85000005 |
| FONT_NOT_FOUND | 0x85000006 |
| FONT_PARAM_OUT_OF_RANGE | 0x85000007 |
| FONT_BAD_UTF8_CODE | 0x85000008 |
| FONT_SYSTEM_ERR | 0x85000009 |

D.6. Native Events and Managed Async CallBack

An entity can call a NotifyOnEventCallback system method (internal only) to register for an event notification. NotifyOnEventCallback is a non-blocking call and the entity does not need to make this call on a separate thread, unless there is some explicit need to do so. There will be a single system thread that will perform the waiting and dispatching for all the callback-oriented events, such as HTTP, MpegFiltering, Tuning, eTV, and so forth. (Exceptions are UserInput, AppLaunch and PingPong events, which are handled by dedicated system threads).

The types of events can be broadly classified into two: multiple instance events and single instance events. HTTP and GuideDB Search represent typical multiple instance models. In these models, a request typically has to be made explicitly (by the entity) to start operation, and multiple threads can be creating different requests. In this model, the caller (to NotifyOnEvent) will pass in the corresponding NSL handle which can be used to distinguish between multiple instances of the same event (for example, multiple HTTP requests from different threads on the same application or from different applications). With the single instance, the entity does not typically need to do anything explicit to initiate a request. The runtime gets these kinds of events automatically and it will dispatch them to the interested party (it is the responsibility of the entity to take that data, parse it appropriately and perform the further dispatching to the consumers of their APIs).

According to one exemplary implementation, at any point in time, there can be only one outstanding request for an Event Type/Handle combination. For example, in one exemplary implementation, it is not possible to make a second HTTP request on the same handle until the first has successfully completed (e.g., the callback has been invoked). This is not a difficult requirement and can be relaxed to some extent if required and if certain conditions are met.

A SpotHost layer will act as an intermediary between the NSL and SPOT environments. With the single instance model, the event will be broadcast to all subscribers. The SpotHost layer will take the event (such as HttpResponse or MpegFilter) from the NSL layer, wrap it into a HAL_DISPATCH_EVENT struct and send it to the system queue using the Toba-EnqueueDispatchEvent function. The entity is responsible for implementing the appropriate function in the SpotHost layer.

When the system takes an event off of the queue for processing, if it cannot find a matching request or if it cannot find any target to dispatch it to (e.g., because the application that made the request has exited), the system will discard the response (after doing appropriate cleanup). Hence, the APIs should register for notification first (by calling NotifyOnEvent) before they perform the initiation. Otherwise, there can be subtle race conditions that may cause the response to be discarded. If the system finds a matching request, it will invoke the corresponding delegate. The entity should not perform any non-trivial work in the delegate handler.

A Dispose method should be called on the NativeResponse object (which invokes the function pointed to by NativeResponse.freeNativeDataFunctionPtr and passes in rawNativeDataPtr as the parameter). If it is desirable to hold onto the native data, it is possible to keep the NativeResponse object; alternatively, it is possible to set the freeNativeDataFunctionPtr field to 0 and then call Dispose. If an exception is thrown by the callback, then the system assumes the worst and calls Dispose on the NativeResponse object. There is no point in performing the cleanup using a Finalizer since both the system and the user will be able to provide guaranteed cleanup.

The system can also provide an explicit API to un-register too; for example, CancelNotificiation(HalDispatchEvents e, uint nativeHandle). Using this functionality, the system has only to be concerned with abnormal termination cases for automatic un-registration.

### USAGE EXAMPLES

```
      Multiple Instance Model
    ==================
    _httpDataPtr = HttpWebResponse.CreateNativeHttpData( ); //create the NSL handle
    /*
    Multiple applications can create Http objects and each request needs to be
uniquely identifiable; hence the need to pass in the NSL handle as the token.
    */
    SystemUtils.NotifyOnEvent(HalDispatchEvents.HTTP, _httpDataPtr, HttpCallback);
    StartRequest( ); //The initiation...
    //go do other stuff...
    void HttpCallback(NativeResponse nr)
    {
        uint rawNativeData = nr.rawNativeDataPtr;
        /* nr.Dispose must be called to dispose of the native resource. If it is
desirable to hold onto the native data, the rawNativeDataPtr field can be set to 0 before
invoking Dispose. Dispose does not have to be performed right here in the callback.*/
        // perform trivial activities and return as soon as possible.
    }
    Single Instance Model
    =================
        MpegFilterApi( )
        {
            /*
    0 => no associated native handle. Though the NSL MpegFilter APIs could have a
handle, there is no need for it here because all instances of the MpegFilter events are
the same. They simply pass on a blob of data to the interested party (in this case, the
MpegFilter managed API)
            */
              NotifyOnEvent(HalDispatchEvents.MpegFilter, 0 /*no native handle*/,
this.MpegFilterCallback);
        }
        void MpegFilterCallback(NativeResponse response)
        {
              byte[ ] filterdata = new byte[response.rawnativedatasize];
              Systemutils.CopyToByteArray(filterdata, response.rawnativedataptr);
    /*
    Call Dispose to get rid of the associated native data.
            */
            response.Dispose( );
    /*perform activity with the byte array but return as soon as possible because this
call is made on a system thread*/
        }
```

The goal here is to provide a very light-weight and “thin” layer for users to receive async callbacks and system events from the NSL/PAL layer (without spawning off a separate thread for each request). The API author can build an IAsyncResult/AsyncCallback based callback mechanism on top of this feature, if so desired.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A set-top box system, comprising:
a hardware layer representing hardware functionality provided by the set-top box system;
an interpreter-based core runtime engine configured for use in a set-top box environment,
wherein the set-top box system is configured to run an application that can perform a function using the hardware layer and the interpreter-based core runtime engine.

2. The set-top box system of claim 1, wherein the hardware functionality includes less than 5 MB of memory.

3. The set-top box system of claim 1, further including an application manager for managing applications, configured for use in the set-top box environment.

4. The set-top box system of claim 3, wherein the application manager is configured to pause a current application when another application is activated, and to resume the current application when the other application is deactivated.

5. The set-top box system of claim 1, further include a UI manager for managing user interface presentations, configured for use in the set-top box environment.

6. The set-top box system of claim 1, further comprising graphics functionality configured to provide a transition effect when switching from one graphical presentation to another.

7. The set-top box system of claim 6, wherein the transition effects include one or more of: decimation; fading; scrolling; and exposing.

8. The set-top box system of claim 1, further comprising graphics functionality configured to change a color palette of a graphical presentation.

9. The set-top box system of claim 1, further comprising graphics functionality configured to change a resolution of a graphical presentation.

10. The set-top box system of claim 1, further comprising graphics functionality configured to simplify font processing by stripping information from font files.

11. The set-top box system of claim 1, further comprising graphics functionality configured to provide anti-aliasing for fonts.

12. The set-top box system of claim 1,
wherein the hardware functionality includes a line control register (LCR) which provides memory locations which correspond to respective lines on a display device, and
wherein the set-top box system further comprises graphics functionality configured to provide a graphics effect by manipulating the LCR.

13. A set-top box system having a limited amount of resources, comprising:
a hardware layer representing hardware functionality provided by the set-top box system; and
an interpreter-based processing module configured for use in a set-top box environment,
wherein the hardware functionality includes a line control register (LCR) which provides memory locations which correspond to respective lines on a display device, and
wherein the set-top box system further comprises graphics functionality configured to provide a graphics effect by manipulating the LCR.

14. One or more machine-readable media containing instructions for implementing the set-top box system of claim 13.

15. A method for executing an application in a resource-constrained set-top box environment, comprising:
loading and initializing a current application;
executing the current application using an interpreter-based processing module configured for use in a set-top box environment;
pausing the current application when another application is activated that interferes with the current application's user graphics presentation;
resuming the current application when the other application is deactivated; and
exiting the current application upon the occurrence of an exit event.

16. The method of claim 15, where the initializing comprises establishing a message thread for the application.

17. The method of claim 15, further comprising providing a transition effect when switching from one graphics presentation to another.

18. The method of claim 15, further comprising changing one or more of the palette and resolution upon switching from one graphics presentation to another.

19. One or more machine-readable media containing instructions for implementing the method of claim 15.

20. A set-top box system including logic configured to implement the method of claim 15.
